(19) United States
(12) Patent Application Publication
(10) Pub. No.: US 2026/0038517 A1
(43) Pub. Date: Feb. 5, 2026

(54) Scene Audio Encoding Method and Electronic Device

(71) Applicant: HUAWEI TECHNOLOGIES CO., LTD., Shenzhen (CN)

(72) Inventors: Yuan Gao, Beijing (CN); Shuai Liu, Beijing (CN); Bingyin Xia, Beijing (CN); Zhe Wang, Beijing (CN)

(73) Assignee: HUAWEI TECHNOLOGIES CO., LTD., Shenzhen (CN)

(21) Appl. No.: 19/355,056

(22) Filed: Oct. 10, 2025

Related U.S. Application Data
(63) Continuation of application No. PCT/CN2024/071724, filed on Jan. 11, 2024.

(30) Foreign Application Priority Data
Apr. 13, 2023 (CN) 202310444553.5

(51) Int. Cl. G10L 19/008; H04S 7/00

(52) U.S. Cl. CPC G10L 19/008; H04S 7/30

(57) ABSTRACT

A scene audio encoding method includes obtaining a scene audio signal. The scene audio encoding method further includes determining an encoding scheme combination corresponding to the scene audio signal from an encoding scheme set, where the encoding scheme set includes a plurality of encoding scheme combinations. The scene audio encoding method further includes encoding the scene audio signal based on the encoding scheme combination corresponding to the scene audio signal.

### CROSS-REFERENCE TO RELATED APPLICATIONS

This is a continuation of International Patent Application No. PCT/CN2024/071724, filed on Jan. 11, 2024, which claims priority to Chinese Patent Application No. 202310444553.5, filed on Apr. 13, 2023, both of which are incorporated by reference.

### TECHNICAL FIELD

Embodiments of this disclosure relate to the audio encoding and decoding field, and in particular, to a scene audio encoding method and an electronic device.

### BACKGROUND

A three-dimensional audio technology is an audio technology for obtaining, processing, transmitting, rendering, and playing back sound events and three-dimensional sound field information in the real world through a computer, signal processing, or the like. Three-dimensional audio enables a sound to have a strong sense of space, envelopment, and immersion, delivering people with extraordinary “immersive” auditory experience. In a higher-order ambisonics (HOA) technology, recording, encoding, and playback stages are irrelevant to a speaker layout, data in a HOA format is rotatably played back. Therefore, the HOA technology has higher flexibility in playback of the three-dimensional audio, and has gained more extensive attention and research.

A channel quantity corresponding to an N-order HOA signal is (N+1)². As an HOA order quantity increases, information used to record a more detailed sound scene in an HOA signal increases accordingly. However, a data amount of the HOA signal also increases accordingly, creating challenges in both transmission and storage. Therefore, the HOA signal needs to be encoded and decoded. However, encoding performance of the HOA signal is low in an example technology.

### SUMMARY

In view of this, this disclosure provides a scene audio encoding method and an electronic device.

According to a first aspect, an embodiment of this disclosure provides a scene audio encoding method. The method includes: obtaining a scene audio signal; determining an encoding scheme combination corresponding to the scene audio signal from an encoding scheme set, where the encoding scheme set includes a plurality of encoding scheme combinations; and encoding the scene audio signal based on the encoding scheme combination corresponding to the scene audio signal.

In this way, an encoding scheme combination used for encoding can be quickly determined by querying a pre-established encoding scheme set, thereby saving time consumed throughout an encoding process and improving encoding efficiency.

For scene audio signals in different scenes, an encoding scheme combination applicable to different scenes may be selected from the pre-established encoding scheme set for encoding. Because an encoding scheme combination with good encoding performance may be selected for establishment of the encoding scheme set, this disclosure can ensure encoding performance of a scene audio signal in each scene to some extent, and improve flexibility.

The encoding scheme combination corresponding to the scene audio signal includes encoding schemes corresponding to a plurality of channels. When encoding schemes corresponding to at least two channels in the encoding schemes corresponding to the plurality of channels are different, compared with a case in which encoding is performed based on a single encoding scheme, when encoding is performed based on the encoding scheme combination, an advantage of one encoding scheme in the encoding scheme combination can be used to compensate for a disadvantage of another encoding scheme to some extent, thereby improving encoding performance to some extent.

In addition, even if the encoding schemes that correspond to the plurality of channels and that are included in the encoding scheme combination corresponding to the scene audio signal are the same, that is, are all a direct encoding scheme (the signal is encoded, for example, operations such as time-frequency transform, preprocessing, bit allocation, quantization, and entropy encoding may be performed on the signal), compared with an example technology, in this disclosure, a channel quantity of the to-be-encoded audio signal is less. Therefore, an encoding bit rate in this disclosure is lower while achieving same quality.

For example, the scene audio signal in this embodiment of this disclosure may be a signal used to describe a sound field. The scene audio signal may include an HOA signal (the HOA signal may include a three-dimensional HOA signal and a two-dimensional HOA signal (which may also be referred to as a planar HOA signal)) and a three-dimensional audio signal. The three-dimensional audio signal may be an audio signal in the scene audio signal other than the HOA signal.

For example, the scene audio signal may include an audio signal with C channels. Cis a positive integer.

For example, when the scene audio signal is an HOA signal, the HOA signal may be an N-order HOA signal.

For example, the N-order HOA signal may include an audio signal with C channels. C=(N+1)². For example, when N=3, the N-order HOA signal includes an audio signal with 16 channels; and when N=4, the N-order HOA signal includes an audio signal with 25 channels.

For example, the scene audio signal may include one or more frames.

For example, each encoding scheme combination in the encoding scheme set may include encoding schemes corresponding to a plurality of channels.

According to the first aspect, one encoding scheme combination in the encoding scheme set corresponds to one type of scene information. The scene information may include information related to the to-be-encoded scene audio signal.

According to any one of the first aspect or the implementations of the first aspect, the scene information includes an encoding rate and/or channel information.

The channel information may include a channel quantity and a channel identifier (for example, a channel number).

According to any one of the first aspect or the implementations of the first aspect, one encoding scheme combination in the encoding scheme set includes encoding schemes corresponding to K channels, where K is a positive integer; and an encoding scheme corresponding to one channel includes at least one of the following: a first encoding scheme, a second encoding scheme, and a third encoding scheme, the first encoding scheme is encoding a signal, the second encoding scheme is a spatial encoding scheme, and the third encoding scheme is an encoding scheme other than the first encoding scheme and the second encoding scheme.

For example, the first encoding scheme may be encoding a signal performing operations such as time-frequency transform, preprocessing, bit allocation, quantization, and entropy encoding on the signal. The first encoding scheme may also be referred to as a direct encoding scheme.

For example, the second encoding scheme may be the spatial encoding scheme, and the spatial encoding scheme is an encoding scheme in which attribute information that is of a target virtual speaker and that is determined based on the scene audio signal is encoded.

For example, the third encoding scheme may include one or more encoding schemes other than the first encoding scheme and the second encoding scheme.

In a possible manner, the third encoding scheme is channel copy (or HOA copy) encoding. Optionally, the third encoding scheme is a de-correlation encoding scheme.

In a possible manner, each encoding scheme combination may include the first encoding scheme and the third encoding scheme.

In a possible manner, each encoding scheme combination may include the first encoding scheme, the second encoding scheme, and the third encoding scheme.

In a possible manner, each encoding scheme combination may include the first encoding scheme and the second encoding scheme.

In a possible manner, each encoding scheme combination may include the first encoding scheme.

Performing encoding based on the first encoding scheme can improve encoding quality, but may require high bit rate overheads; and performing encoding based on another encoding scheme (the second encoding scheme or the third encoding scheme) can reduce bit rate overheads, but reduces encoding quality. Therefore, performing encoding based on a combination of the first encoding scheme and the other encoding scheme in this disclosure reduces bit rate overheads and encoding complexity while ensuring encoding quality to some extent.

According to any one of the first aspect or the implementations of the first aspect, encoding schemes corresponding to at least two channels in the encoding schemes corresponding to the K channels are different.

It should be understood that, in a possible case, encoding schemes corresponding to all channels in one encoding scheme combination in the encoding scheme set are the same.

According to any one of the first aspect or the implementations of the first aspect, the scene audio signal includes an audio signal with C channels, the encoding scheme combination corresponding to the scene audio signal includes encoding schemes corresponding to the C channels, and encoding the scene audio signal based on the encoding scheme combination corresponding to the scene audio signal includes: encoding the C channels in the scene audio signal based on the encoding schemes corresponding to the C channels, where C is a positive integer.

According to any one of the first aspect or the implementations of the first aspect, determining the encoding scheme combination corresponding to the scene audio signal from the encoding scheme set includes: searching the encoding scheme set for the encoding scheme combination corresponding to the scene audio signal based on current scene information.

According to any one of the first aspect or the implementations of the first aspect, when one encoding scheme combination in the encoding scheme set corresponds to one encoding rate, searching the encoding scheme set for the encoding scheme combination corresponding to the scene audio signal based on the current scene information includes: searching the encoding scheme set for the encoding scheme combination corresponding to the scene audio signal based on a current encoding rate.

In this way, the encoding scheme combination used for encoding is selected from the encoding scheme set based on the current encoding rate, so that encoding can adapt to the current encoding rate, thereby ensuring audio smoothness.

According to any one of the first aspect or the implementations of the first aspect, the scene audio signal includes an audio signal with C channels, and searching the encoding scheme set for the encoding scheme combination corresponding to the scene audio signal based on the current encoding rate includes: searching the encoding scheme set for a plurality of encoding scheme combinations corresponding to the current encoding rate, where the plurality of encoding scheme combinations corresponding to the current encoding rate correspond to a plurality of channel quantities; and searching the plurality of encoding scheme combinations corresponding to the current encoding rate for the encoding scheme combination corresponding to the scene audio signal based on a channel quantity C of the scene audio signal.

In this way, the encoding scheme combination used for encoding is selected from the encoding scheme set based on the current encoding rate and the channel quantity of the scene audio signal, so that encoding can adapt to the current encoding rate, thereby ensuring audio smoothness. In addition, this is also applicable to encoding of scene audio signals including different channel quantities, and is highly universal. In addition, because the encoding scheme combination with good encoding performance may be selected for establishment of the encoding scheme set, this disclosure can also ensure, to some extent, encoding quality of various scene audio signals including different channel quantities.

According to any one of the first aspect or the implementations of the first aspect, the scene audio signal includes an audio signal with C channels, and searching the encoding scheme set for the encoding scheme combination corresponding to the scene audio signal based on the current encoding rate includes: searching the encoding scheme set for an encoding scheme combination corresponding to the current encoding rate, where the encoding scheme combination corresponding to the current encoding rate includes encoding schemes corresponding to K channels, and K is an integer greater than or equal to C; and selecting encoding schemes corresponding to the C channels in the scene audio signal from the encoding scheme combination corresponding to the current encoding rate, to form the encoding scheme combination corresponding to the scene audio signal.

In this way, the encoding scheme combination used for encoding is selected from the encoding scheme set based on the current encoding rate and the channel identifier of the scene audio signal, so that encoding can adapt to the current encoding rate, thereby ensuring audio smoothness. In addition, this is also applicable to encoding of scene audio signals including different channel quantities, and is highly universal. In addition, because the encoding scheme combination with good encoding performance may be selected for establishment of the encoding scheme set, this disclosure can also ensure, to some extent, encoding quality of various scene audio signals including different channel quantities.

According to any one of the first aspect or the implementations of the first aspect, the scene audio signal includes an audio signal with C channels, and when one encoding scheme combination in the encoding scheme set corresponds to one channel quantity, searching the encoding scheme set for the encoding scheme combination corresponding to the scene audio signal based on the current scene information includes: searching the encoding scheme set for the encoding scheme combination corresponding to the scene audio signal based on a channel quantity C of the scene audio signal.

In this way, selecting the encoding scheme combination used for encoding from the encoding scheme set based on the channel quantity of the scene audio signal is applicable to encoding of scene audio signals including different channel quantities, and is highly universal. In addition, because the encoding scheme combination with good encoding performance may be selected for establishment of the encoding scheme set, this disclosure can also ensure, to some extent, encoding quality of various scene audio signals including different channel quantities.

According to any one of the first aspect or the implementations of the first aspect, the spatial encoding scheme is an encoding scheme in which attribute information of a target virtual speaker is encoded, and the attribute information of the target virtual speaker is determined based on the scene audio signal.

It should be noted that a location of the target virtual speaker matches a location of a sound source in the scene audio signal; a virtual speaker signal corresponding to the target virtual speaker may be generated based on the attribute information of the target virtual speaker and an audio signal with a part of channels in the scene audio signal; and the scene audio signal may be reconstructed based on the virtual speaker signal. Therefore, an encoder side encodes the audio signal with the part of channels in the scene audio signal and the attribute information of the target virtual speaker, and then sends the encoded audio signal and the encoded attribute information to a decoder side. The decoder side may reconstruct the scene audio signal based on a reconstructed audio signal with the part of channels and the attribute information of the target virtual speaker that are obtained through decoding.

A data amount of the attribute information of the target virtual speaker is far less than a data amount of an audio signal with one channel. Therefore, compared with encoding performed based on the first encoding scheme, encoding performed based on the second encoding scheme may require fewer bit rate overheads.

The attribute information of the target virtual speaker includes at least one of the following: location information of the target virtual speaker, a location index corresponding to the location information of the target virtual speaker, or a virtual speaker index of the target virtual speaker.

For example, in a spherical coordinate system, the location information of the target virtual speaker may be, for example, (θₛ₃, φₛ₃). Herein, θₛ₃ is horizontal angle information of the target virtual speaker, and φₛ₃ is pitch angle information of the target virtual speaker.

For example, the location index is used to uniquely identify a location of a virtual speaker. The location index may include a horizontal angle index (used to uniquely identify one piece of horizontal angle information) and a pitch angle index (used to uniquely identify one piece of pitch angle information). The location index of the virtual speaker is in one-to-one correspondence with location information of the virtual speaker.

For example, the virtual speaker index may be used to uniquely identify a virtual speaker, and the location information/location index of the virtual speaker is in one-to-one correspondence with the virtual speaker index.

According to any one of the first aspect or the implementations of the first aspect, the third encoding scheme includes channel copy encoding.

According to any one of the first aspect or the implementations of the first aspect, the channel copy encoding is a de-correlation encoding scheme.

According to any one of the first aspect or the implementations of the first aspect, a preset identifier is encoded. The preset identifier indicates a type of the scene information. In this way, after the preset identifier is transmitted to the decoder side, a decoder performs decoding based on a decoding scheme combination corresponding to an encoding scheme combination of the encoder side.

According to a second aspect, an embodiment of this disclosure provides a scene audio decoding method. The decoding method includes: receiving a bitstream; determining a decoding scheme combination corresponding to the bitstream from a decoding scheme set, where the decoding scheme set includes a plurality of decoding scheme combinations; and decoding the bitstream based on the decoding scheme combination corresponding to the bitstream, to obtain a reconstructed scene audio signal.

In this way, a decoding scheme combination used for decoding can be quickly determined by querying a pre-established decoding scheme set, thereby saving time consumed in an entire decoding process and improving decoding efficiency.

For different scene audio signals, a decoding scheme combination applicable to different scenes may be selected from the pre-established decoding scheme set for decoding. Because an encoding scheme combination (a decoding scheme combination corresponds to the encoding scheme combination) with good encoding performance may be selected for establishment of the encoding scheme set, this disclosure can ensure audio reconstruction quality of different scenes to some extent, and improve flexibility.

According to the second aspect, one decoding scheme combination in the decoding scheme set corresponds to one type of scene information.

According to any one of the second aspect or the implementations of the second aspect, the scene information includes a decoding rate and/or channel information.

According to any one of the second aspect or the implementations of the second aspect, one decoding scheme combination in the decoding scheme set includes decoding schemes corresponding to K channels, where K is a positive integer; and a decoding scheme corresponding to one channel includes at least one of the following: a first decoding scheme, a second decoding scheme, and a third decoding scheme, the first decoding scheme is decoding a signal, the second decoding scheme is a spatial decoding scheme, and the third decoding scheme is a decoding scheme other than the first decoding scheme and the second decoding scheme.

According to any one of the second aspect or the implementations of the second aspect, decoding schemes corresponding to at least two channels in the decoding schemes corresponding to the K channels are different.

According to any one of the second aspect or the implementations of the second aspect, the reconstructed scene audio signal includes a reconstructed audio signal with C channels, the decoding scheme combination corresponding to the bitstream includes decoding schemes corresponding to the C channels, and decoding the bitstream based on the decoding scheme combination corresponding to the bitstream, to obtain the reconstructed scene audio signal includes: decoding the C channels based on the bitstream and the decoding schemes corresponding to the C channels, to obtain the reconstructed scene audio signal, where C is a positive integer.

According to any one of the second aspect or the implementations of the second aspect, determining the decoding scheme combination corresponding to the bitstream from the decoding scheme set includes: searching the decoding scheme set for the decoding scheme combination corresponding to the bitstream based on current scene information.

According to any one of the second aspect or the implementations of the second aspect, when one decoding scheme combination in the decoding scheme set corresponds to one decoding rate, searching the decoding scheme set for the decoding scheme combination corresponding to the bitstream based on the current scene information includes: searching the decoding scheme set for the decoding scheme combination corresponding to the bitstream based on a current decoding rate.

According to any one of the second aspect or the implementations of the second aspect, the reconstructed scene audio signal includes a reconstructed audio signal with C channels, and searching the decoding scheme set for the decoding scheme combination corresponding to the bitstream based on the current decoding rate includes: searching the decoding scheme set for a plurality of decoding scheme combinations corresponding to the current decoding rate, where the plurality of decoding scheme combinations corresponding to the current decoding rate correspond to a plurality of channel quantities; and determining the decoding scheme combination corresponding to the bitstream from the plurality of decoding scheme combinations corresponding to the current decoding rate based on a channel quantity C of the reconstructed scene audio signal.

According to any one of the second aspect or the implementations of the second aspect, the reconstructed scene audio signal includes a reconstructed audio signal with C channels, and searching the decoding scheme set for the decoding scheme combination corresponding to the bitstream based on the current decoding rate includes: determining a decoding scheme combination corresponding to the current decoding rate from the decoding scheme set, where the decoding scheme combination corresponding to the current decoding rate includes decoding schemes corresponding to K channels, and K is greater than or equal to C; and selecting decoding schemes corresponding to the C channels in the reconstructed scene audio signal from the decoding scheme combination corresponding to the current decoding rate, to form the decoding scheme combination corresponding to the bitstream.

According to any one of the second aspect or the implementations of the second aspect, the reconstructed scene audio signal includes a reconstructed audio signal with C channels, and when one decoding scheme combination in the decoding scheme set corresponds to one channel quantity, searching the decoding scheme set for the decoding scheme combination corresponding to the bitstream based on the current scene information includes: determining the decoding scheme combination corresponding to the bitstream from the decoding scheme set based on a channel quantity C of the reconstructed scene audio signal.

According to any one of the second aspect or the implementations of the second aspect, the spatial decoding scheme is a decoding scheme in which reconstruction is performed based on attribute information of a target virtual speaker, and information about the target virtual speaker is obtained by decoding the bitstream.

According to any one of the second aspect or the implementations of the second aspect, the third decoding scheme includes channel copy decoding.

According to any one of the second aspect or the implementations of the second aspect, the channel copy decoding is a de-correlation decoding scheme.

According to any one of the second aspect or the implementations of the second aspect, the method further includes: parsing out a preset identifier from the bitstream; and searching the decoding scheme set for the decoding scheme combination corresponding to the bitstream based on the current scene information includes: searching the decoding scheme set for the decoding scheme combination corresponding to the bitstream based on current scene information corresponding to the preset identifier.

Any one of the second aspect and the implementations of the second aspect corresponds to any one of the first aspect and the implementations of the first aspect. For technical effect corresponding to any one of the second aspect and the implementations of the second aspect, refer to technical effect corresponding to any one of the first aspect and the implementations of the first aspect. Details are not described herein again.

According to a third aspect, an embodiment of this disclosure provides a bitstream generation method. In the method, a bitstream may be generated according to any one of the first aspect or the implementations of the first aspect.

Any one of the third aspect and the implementations of the third aspect corresponds to any one of the first aspect and the implementations of the first aspect. For technical effect corresponding to any one of the third aspect and the implementations of the third aspect, refer to technical effect corresponding to any one of the first aspect and the implementations of the first aspect. Details are not described herein again.

According to a fourth aspect, an embodiment of this disclosure provides a scene audio encoding apparatus. The apparatus includes: a signal obtaining module configured to obtain a scene audio signal; an encoding scheme determining module configured to determine an encoding scheme combination corresponding to the scene audio signal from an encoding scheme set, where the encoding scheme set includes a plurality of encoding scheme combinations; and an encoding module configured to encode the scene audio signal based on the encoding scheme combination corresponding to the scene audio signal.

The scene audio encoding apparatus in the fourth aspect may perform the steps in any one of the first aspect and the implementations of the first aspect. Details are not described herein again.

In addition, the scene audio encoding apparatus in the fourth aspect may further include a communication module.

Any one of the fourth aspect and the implementations of the fourth aspect corresponds to any one of the first aspect and the implementations of the first aspect. For technical effect corresponding to any one of the fourth aspect and the implementations of the fourth aspect, refer to technical effect corresponding to any one of the first aspect and the implementations of the first aspect. Details are not described herein again.

According to a fifth aspect, an embodiment of this disclosure provides a scene audio decoding apparatus. The apparatus includes: a bitstream receiving module configured to receive a bitstream; a decoding scheme determining module configured to determine a decoding scheme combination corresponding to the bitstream from a decoding scheme set, where the decoding scheme set includes a plurality of decoding scheme combinations; and a decoding module configured to decode the bitstream based on the decoding scheme combination corresponding to the bitstream, to obtain a reconstructed scene audio signal.

The scene audio decoding apparatus in the fifth aspect may perform the steps in any one of the second aspect and the implementations of the second aspect. Details are not described herein again.

In addition, the scene audio decoding apparatus in the fifth aspect may further include a communication module.

Any one of the fifth aspect and the implementations of the fifth aspect corresponds to any one of the second aspect and the implementations of the second aspect. For technical effect corresponding to any one of the fifth aspect and the implementations of the fifth aspect, refer to technical effect corresponding to any one of the second aspect and the implementations of the second aspect. Details are not described herein again.

According to a sixth aspect, an embodiment of this disclosure provides an electronic device, including a memory and a processor. The memory is coupled to the processor, the memory stores program instructions, and when the program instructions are executed by the processor, the electronic device is enabled to perform the scene audio encoding method according to any one of the first aspect or the possible implementations of the first aspect.

Any one of the sixth aspect and the implementations of the sixth aspect corresponds to any one of the first aspect and the implementations of the first aspect. For technical effect corresponding to any one of the sixth aspect and the implementations of the sixth aspect, refer to technical effect corresponding to any one of the first aspect and the implementations of the first aspect. Details are not described herein again.

According to a seventh aspect, an embodiment of this disclosure provides an electronic device, including a memory and a processor. The memory is coupled to the processor, the memory stores program instructions, and when the program instructions are executed by the processor, the electronic device is enabled to perform the scene audio decoding method according to any one of the second aspect or the possible implementations of the second aspect.

Any one of the seventh aspect and the implementations of the seventh aspect corresponds to any one of the second aspect and the implementations of the second aspect. For technical effect corresponding to any one of the seventh aspect and the implementations of the seventh aspect, refer to technical effect corresponding to any one of the second aspect and the implementations of the second aspect. Details are not described herein again.

According to an eighth aspect, an embodiment of this disclosure provides a chip, including one or more interface circuits and one or more processors. The one or more processors receive or send data through the one or more interface circuits. When the one or more processors execute computer instructions, the electronic device is enabled to perform the scene audio encoding method according to any one of the first aspect or the possible implementations of the first aspect.

Any one of the eighth aspect and the implementations of the eighth aspect corresponds to any one of the first aspect and the implementations of the first aspect. For technical effect corresponding to any one of the eighth aspect and the implementations of the eighth aspect, refer to technical effect corresponding to any one of the first aspect and the implementations of the first aspect. Details are not described herein again.

According to a ninth aspect, an embodiment of this disclosure provides a chip, including one or more interface circuits and one or more processors. The one or more processors receive or send data through the one or more interface circuits. When the one or more processors execute computer instructions, the electronic device is enabled to perform the scene audio decoding method according to any one of the second aspect or the possible implementations of the second aspect.

Any one of the ninth aspect and the implementations of the ninth aspect corresponds to any one of the second aspect and the implementations of the second aspect. For technical effect corresponding to any one of the ninth aspect and the implementations of the ninth aspect, refer to technical effect corresponding to any one of the second aspect and the implementations of the second aspect. Details are not described herein again.

According to a tenth aspect, an embodiment of this disclosure provides a computer-readable storage medium. The computer-readable storage medium stores a computer program. When the computer program is run on a computer or a processor, the computer or the processor is enabled to perform the scene audio encoding method according to any one of the first aspect or the possible implementations of the first aspect.

Any one of the tenth aspect and the implementations of the tenth aspect corresponds to any one of the first aspect and the implementations of the first aspect. For technical effect corresponding to any one of the tenth aspect and the implementations of the tenth aspect, refer to technical effect corresponding to any one of the first aspect and the implementations of the first aspect. Details are not described herein again.

According to an eleventh aspect, an embodiment of this disclosure provides a computer-readable storage medium. The computer-readable storage medium stores a computer program. When the computer program is run on a computer or a processor, the computer or the processor is enabled to perform the scene audio decoding method according to any one of the second aspect or the possible implementations of the second aspect.

Any one of the eleventh aspect and the implementations of the eleventh aspect corresponds to any one of the second aspect and the implementations of the second aspect. For technical effect corresponding to any one of the eleventh aspect and the implementations of the eleventh aspect, refer to technical effect corresponding to any one of the second aspect and the implementations of the second aspect. Details are not described herein again.

According to a twelfth aspect, an embodiment of this disclosure provides a computer program product. The computer program product includes a software program. When the software program is executed by a computer or a processor, the computer or the processor is enabled to perform the scene audio encoding method according to any one of the first aspect or the possible implementations of the first aspect.

Any one of the twelfth aspect and the implementations of the twelfth aspect corresponds to any one of the first aspect and the implementations of the first aspect. For technical effect corresponding to any one of the twelfth aspect and the implementations of the twelfth aspect, refer to technical effect corresponding to any one of the first aspect and the implementations of the first aspect. Details are not described herein again.

According to a thirteenth aspect, an embodiment of this disclosure provides a computer program product. The computer program product includes a software program. When the software program is executed by a computer or a processor, the computer or the processor is enabled to perform the scene audio decoding method according to any one of the second aspect or the possible implementations of the second aspect.

Any one of the thirteenth aspect and the implementations of the thirteenth aspect corresponds to any one of the second aspect and the implementations of the second aspect. For technical effect corresponding to any one of the thirteenth aspect and the implementations of the thirteenth aspect, refer to technical effect corresponding to any one of the second aspect and the implementations of the second aspect. Details are not described herein again.

According to a fourteenth aspect, an embodiment of this disclosure provides a bitstream storage apparatus. The apparatus includes a receiver and at least one storage medium. The receiver is configured to receive a bitstream. The at least one storage medium is configured to store the bitstream. The bitstream is generated according to any one of the first aspect and the implementations of the first aspect.

Any one of the fourteenth aspect and the implementations of the fourteenth aspect corresponds to any one of the first aspect and the implementations of the first aspect. For technical effect corresponding to any one of the fourteenth aspect and the implementations of the fourteenth aspect, refer to technical effect corresponding to any one of the first aspect and the implementations of the first aspect. Details are not described herein again.

According to a fifteenth aspect, an embodiment of this disclosure provides a bitstream transmission apparatus. The apparatus includes a transmitter and at least one storage medium. The at least one storage medium is configured to store a bitstream. The bitstream is generated according to any one of the first aspect and the implementations of the first aspect. The transmitter is configured to: receive the bitstream from the storage medium, and send the bitstream to a terminal-side device through a transmission medium.

Any one of the fifteenth aspect and the implementations of the fifteenth aspect corresponds to any one of the first aspect and the implementations of the first aspect. For technical effect corresponding to any one of the fifteenth aspect and the implementations of the fifteenth aspect, refer to technical effect corresponding to any one of the first aspect and the implementations of the first aspect. Details are not described herein again.

According to sixteenth aspect, an embodiment of this disclosure provides a bitstream distribution system. The system includes: at least one storage medium configured to store at least one bitstream, where the at least one bitstream is generated according to any one of the first aspect and the implementations of the first aspect; and a streaming media device, configured to: obtain a target bitstream from the at least one storage medium, and send the target bitstream to a terminal-side device, where the streaming media device includes a content server or a content delivery server.

Any one of the sixteenth aspect and the implementations of the sixteenth aspect corresponds to any one of the first aspect and the implementations of the first aspect. For technical effect corresponding to any one of the sixteenth aspect and the implementations of the sixteenth aspect, refer to technical effect corresponding to any one of the first aspect and the implementations of the first aspect. Details are not described herein again.

### BRIEF DESCRIPTION OF DRAWINGS

FIG. 1A is a diagram of an example application scenario.

FIG. 1B is a diagram of an example application scenario.

FIG. 2 is a diagram of an example scene audio signal encoding process.

FIG. 3 is a diagram of an example scene audio signal decoding process.

FIG. 4A is a diagram of an example scene audio signal encoding process.

FIG. 4B is a diagram of an example distribution of candidate virtual speakers.

FIG. 5 is a diagram of an example scene audio signal decoding process.

FIG. 6 is a diagram of an example scene audio signal encoding process.

FIG. 7 is a diagram of an example scene audio signal decoding process.

FIG. 8 is a diagram of an example scene audio signal encoding process.

FIG. 9 is a diagram of an example scene audio signal decoding process.

FIG. 10 is a diagram of a structure of an example apparatus.

### DETAILED DESCRIPTION

The following clearly describes the technical solutions in embodiments of this disclosure with reference to the accompanying drawings in embodiments of this disclosure. It is clear that the described embodiments are some but not all of embodiments of this disclosure. All other embodiments obtained by a person of ordinary skill in the art based on embodiments of this disclosure without creative efforts shall fall within the protection scope of this disclosure.

The term “and/or” in this specification describes only an association relationship for describing associated objects and represents that three relationships may exist. For example, A and/or B may represent the following three cases: Only A exists, both A and B exist, and only B exists.

In the specification and claims in embodiments of this disclosure, the terms “first”, “second”, and so on are intended to distinguish between different objects but do not indicate a particular order of the objects. For example, a first target object, a second target object, and the like are used for distinguishing between different target objects, but are not used for describing a specific order of the target objects.

In embodiments of this disclosure, the word such as “example” or “for example” represents giving an example, an illustration, or a description. Any embodiment or design scheme described as an “example” or “for example” in embodiments of this disclosure should not be explained as being more preferred or having more advantages than another embodiment or design scheme. To be precise, use of the word such as “example” or “for example” is intended to present a relative concept in a specific manner.

In descriptions of embodiments of this disclosure, “a plurality of” means two or more, unless otherwise specified. For example, a plurality of processing units mean two or more processing units, and a plurality of systems mean two or more systems.

For clear and brief description of the following embodiments, a brief description of a related technology is first provided.

A sound is a continuous wave generated by an object through vibration. An object that vibrates to emit a sound wave is referred to as a sound source. In a process in which the sound wave is propagated through a medium (for example, air, solid, or liquid), an auditory organ of a human or an animal can sense the sound.

Features of the sound wave include a tone, intensity, and a timbre. The tone indicates a level of the sound. The intensity indicates volume of the sound. The intensity may also be referred to as loudness or volume. A unit of the intensity is decibels (dB). The timbre is also referred to as sound quality.

A frequency of the sound wave determines the level of the tone. A higher frequency indicates a higher tone. A quantity of times that the object vibrates in 1 second is referred to as a frequency, and a frequency unit is hertz (Hz). A frequency of a sound that can be recognized by a human ear is between 20 Hz and 20000 Hz.

An amplitude of the sound wave determines the intensity. A larger amplitude indicates higher intensity. A shorter distance from the sound source indicates higher intensity.

A waveform of the sound wave determines the timbre. Waveforms of sound waves include a square wave, a sawtooth wave, a sine wave, a pulse wave, and the like.

Sounds may be classified into a regular sound and an irregular sound based on features of sound waves. The irregular sound is a sound emitted by the sound source through irregular vibration. The irregular sound is, for example, noise that affects people's work, study, rest, and the like. The regular sound is a sound emitted by the sound source through regular vibration. Regular sounds include a voice and a music sound. When a sound is represented electrically, the regular sound is an analog signal that changes continuously in time-frequency domain. The analog signal may be referred to as an audio signal. The audio signal is an information carrier that carries a voice, music, and a sound effect.

Because human's auditory sense has a capability of distinguishing location distribution of the sound source in space, when hearing a sound in space, a listener can sense a direction and a location of the sound in addition to a tone, intensity, and a timbre of the sound.

As attention to and quality requirements for experience of an auditory system increase, a three-dimensional audio technology emerges accordingly, to enhance a sense of depth, a sense of presence, and a sense of space of a sound. Therefore, the listener not only senses sounds emitted from front, back, left, and right sound sources, but also senses a feeling that space in which the listener is located is enveloped by spatial sound fields (briefly referred to as “sound field”) generated by these sound sources, and a feeling that the sounds diffuse around, to create an “immersive” sound effect exerted when the listener is located in a place such as a theater or a concert hall.

A scene audio signal in embodiments of this disclosure may be a signal used to describe a sound field. The scene audio signal may include an HOA signal (the HOA signal may include a three-dimensional HOA signal and a two-dimensional HOA signal (which may also be referred to as a planar HOA signal)) and a three-dimensional audio signal. The three-dimensional audio signal may be an audio signal in the scene audio signal other than the HOA signal. The following provides descriptions by using the HOA signal as an example.

It is well known that the sound wave is propagated in an ideal medium, a quantity of waves is k-w/c, and an angular frequency is w=2 πf. Herein, f is a sound wave frequency, and c is a sound speed. Sound pressure p satisfies Formula (1). Herein, ∇² is a Laplacian operator.

$${∇}^{2} p + {k}^{2} p = 0 \qquad ( 1 )$$

It is assumed that a spatial system outside the human ear is a sphere, and the listener is at a center of the sphere. A sound transmitted from the outside of the sphere has a projection on a spherical surface, and a sound outside the spherical surface is filtered out. It is assumed that a sound source is distributed on the spherical surface, and a sound field generated by the sound source on the spherical surface fits a sound field generated by an original sound source. That is, the three-dimensional audio technology is a sound field fitting method. For example, an equation, namely, Formula (1) is solved in a spherical coordinate system. In a passive spherical area, a solution to the equation, namely, Formula (1) is Formula (2).

$$p ( r , θ , φ , k ) = s {\sum }_{m = 0}^{∞} ( 2 m + 1 ) {j}^{m} {j}_{m}^{kr} ( kr ) {\sum }_{0 < n < m , σ = \pm 1} {Y}_{m , n}^{σ} ( {θ}_{s} , {φ}_{s} ) {Y}_{m , n}^{σ} ( θ , φ ) \qquad ( 2 )$$

Herein, r represents a sphere radius, θ represents horizontal angle information (or referred to as azimuth information), φ represents pitch angle information (or referred to as elevation angle information), k represents the quantity of waves, s represents an amplitude of an ideal plane wave, and m represents a sequence number of an order quantity of the HOA signal. j^{m} jₘ^{kr} (kr) represents a sphere Bessel function, and the sphere Bessel function is also referred to as a radial basis function. First “j” represents an imaginary unit, and (2m+1) j^{m} jₘ^{kr} (kr) does not change with an angle. Y_{m,n}^{σ} (θ, φ) represents a spherical harmonic function in directions of θ and φ, and Y_{m,n}^{σ} (θₛ, φₛ) represents a spherical harmonic function in a direction of the sound source. The HOA signal satisfies Formula (3).

$${B}_{m , n}^{σ} = s \cdot {Y}_{m , n}^{σ} ( {θ}_{s} , {φ}_{s} ) \qquad ( 3 )$$

Formula (3) is substituted into Formula (2), and Formula (2) may be deformed into Formula (4).

$$p ( r , θ , φ , k ) = {\sum }_{m = 0}^{∞} {j}^{m} {j}_{m}^{kr} ( kr ) {\sum }_{0 \leq n \leq m , σ = \pm 1} {B}_{m , n}^{σ} {Y}_{m , n}^{σ} ( θ , φ ) \qquad ( 4 )$$

Herein, m is truncated to an N1^{th} item, that is, m=N1, and B_{m,n}^{σ} is used as an approximate description of the sound field. In this case, B_{m,n}^{σ} may be referred to as an HOA coefficient (which may be used to represent an N1-order HOA signal). The sound field is an area in which a sound wave exists in a medium. N1 is an integer greater than or equal to 1.

The scene audio signal is an information carrier that carries spatial location information of a sound source in the sound field, and describes a sound field of a listener in space. Formula (4) indicates that the sound field may be expanded on the spherical surface based on the spherical harmonic function. In other words, the sound field may be decomposed into superimposition of a plurality of plane waves. Therefore, the sound field described by the HOA signal may be expressed through superimposition of a plurality of plane waves, and the sound field is reconstructed based on the HOA coefficient.

A to-be-encoded HOA signal in embodiments of this disclosure may be an N1-order HOA signal, and may be represented by using an HOA coefficient or an ambisonic coefficient. N1 is an integer greater than or equal to 1 (when N1 is equal to 1, a 1-order HOA signal may be referred to as an FOA (first-order ambisonics, first-order ambisonics) signal). The N1-order HOA signal includes an audio signal with (N1+1)² channels.

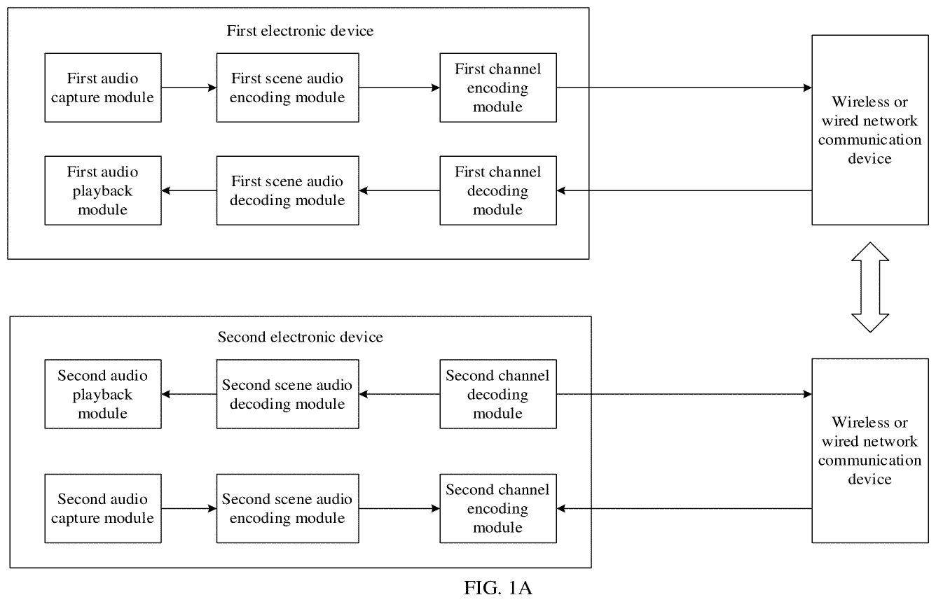

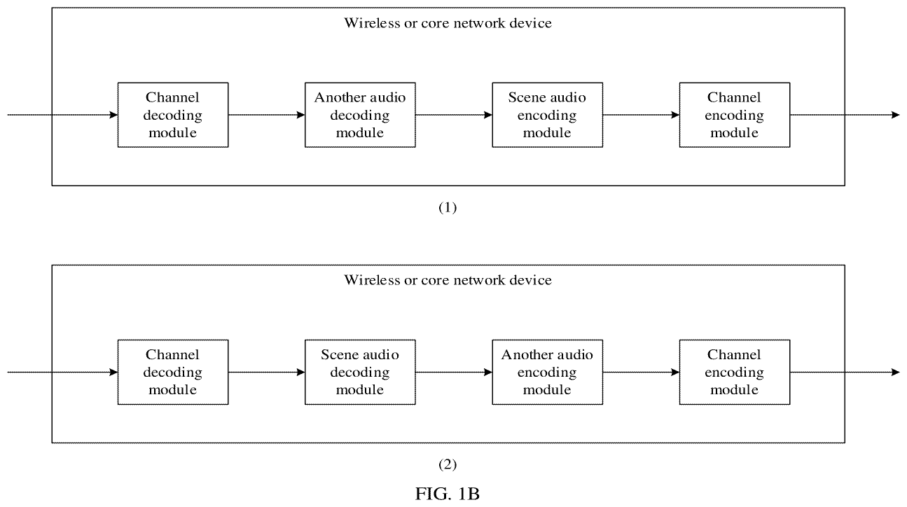

FIG. 1A is a diagram of an example application scenario. FIG. 1A shows a scenario of encoding and decoding a scene audio signal.

As shown in FIG. 1A, for example, a first electronic device may include a first audio capture module, a first scene audio encoding module, a first channel encoding module, a first channel decoding module, a first scene audio decoding module, and a first audio playback module. It should be understood that the first electronic device may include more or fewer modules than those shown in FIG. 1A. This is not limited in this disclosure.

As shown in FIG. 1A, for example, a second electronic device may include a second audio capture module, a second scene audio encoding module, a second channel encoding module, a second channel decoding module, a second scene audio decoding module, and a second audio playback module. It should be understood that the second electronic device may include more or fewer modules than those shown in FIG. 1A. This is not limited in this disclosure.

For example, a process in which the first electronic device encodes the scene audio signal and transmits the encoded scene audio signal to the second electronic device, and the second electronic device performs decoding and audio playback may be as follows: The first audio capture module may perform audio capture, and output the scene audio signal to the first scene audio encoding module. Then, the first scene audio encoding module may encode the scene audio signal, and output a bitstream to the first channel encoding module. Then, the first channel encoding module may perform channel encoding on the bitstream, and transmit, to the second electronic device through a wireless or wired network communication device, a bitstream obtained through channel encoding. Then, the second channel decoding module of the second electronic device may perform channel decoding on received data, to obtain a bitstream and output the bitstream to the second scene audio decoding module. Then, the second scene audio decoding module may decode the bitstream, to obtain a reconstructed scene audio signal; and then output the reconstructed scene audio signal to the second audio playback module, and the second audio playback module performs audio playback.

It should be noted that the second audio playback module may perform post-processing (for example, audio rendering (for example, a reconstructed scene audio signal including an audio signal with (N1+1)² channels may be converted into an audio signal with a same channel quantity as a quantity of speakers in the second electronic device), loudness normalization, user interaction, audio format conversion, or denoising) on the reconstructed scene audio signal, to convert the reconstructed scene audio signal into an audio signal suitable for playing by the speaker in the second electronic device.

It should be understood that a process in which the second electronic device encodes a scene audio signal and transmits the encoded scene audio signal to the first electronic device, and the first electronic device performs decoding and audio playback is similar to the foregoing process in which the first electronic device transmits the scene audio signal to the second electronic device, and the second electronic device performs audio playback. Details are not described herein again.

For example, the first electronic device and the second electronic device each may include but are not limited to a personal computer, a computer workstation, a smartphone, a tablet computer, a server, a smart camera, an intelligent vehicle, another type of cellular phone, a media consumption device, a wearable device, a set-top box, a game console, and the like.

For example, this disclosure may be applied to a virtual reality (VR)/augmented reality (AR) scenario. In a possible manner, the first electronic device is a server, and the second electronic device is a VR/AR device. In a possible manner, the second electronic device is a server, and the first electronic device is a VR/AR device.

For example, the first scene audio encoding module and the second scene audio encoding module may be scene audio encoders. The first scene audio decoding module and the second scene audio decoding module may be scene audio decoders.

For example, when the first electronic device encodes the scene audio signal, and the second electronic device reconstructs the scene audio signal, the first electronic device may be referred to as an encoder side, and the second electronic device may be referred to as a decoder side. When the second electronic device encodes the scene audio signal, and the first electronic device reconstructs the scene audio signal, the second electronic device may be referred to as an encoder side, and the first electronic device may be referred to as a decoder side.

FIG. 1B is a diagram of an example application scenario. FIG. 1B shows a transcoding scenario of a scene audio signal.

As shown in (1) in FIG. 1B, for example, a wireless or core network device may include a channel decoding module, another audio decoding module, a scene audio encoding module, and a channel encoding module. The wireless or core network device may be configured to perform audio transcoding.

For example, an application scenario in (1) in FIG. 1B may be as follows: A first electronic device is not provided with a scene audio encoding module, and is provided with only another audio encoding module. A second electronic device is provided with only a scene audio decoding module, and is not provided with another audio decoding module. The wireless or core network device may be used for transcoding, so that the second electronic device can decode and play back a scene audio signal encoded by the first electronic device by using the other audio encoding module.

For example, the first electronic device encodes the scene audio signal by using the other audio encoding module, to obtain a first bitstream; and performs channel encoding on the first bitstream and sends the encoded first bitstream to the wireless or core network device. Then, the channel decoding module of the wireless or core network device may perform channel decoding, and output, to the other audio decoding module, the first bitstream obtained through channel decoding. Then, the other audio decoding module decodes the first bitstream, to obtain the scene audio signal, and outputs the scene audio signal to the scene audio encoding module. Then, the scene audio encoding module may encode the scene audio signal, to obtain a second bitstream, and output the second bitstream to the channel encoding module. After performing channel encoding on the second bitstream, the channel encoding module sends the encoded second bitstream to the second electronic device. In this way, the second electronic device may invoke the scene audio decoding module to decode the second bitstream obtained through channel decoding, to obtain a reconstructed scene audio signal; and subsequently, may perform audio playback on the reconstructed scene audio signal.

As shown in (2) in FIG. 1B, for example, a wireless or core network device may include a channel decoding module, a scene audio decoding module, another audio encoding module, and a channel encoding module. The wireless or core network device may be configured to perform audio transcoding.

For example, a specific application scenario in (2) in FIG. 1B may be as follows: A first electronic device is provided with only a scene audio encoding module, and is not provided with another audio encoding module. A second electronic device is not provided with a scene audio decoding module, and is only provided with another audio decoding module. The wireless or core network device may be used for transcoding, so that the second electronic device can decode and play back a scene audio signal encoded by the first electronic device by using the scene audio encoding module.

For example, the first electronic device encodes the scene audio signal by using the scene audio encoding module, to obtain a first bitstream; and performs channel encoding on the first bitstream and sends the encoded first bitstream to the wireless or core network device. Then, the channel decoding module of the wireless or core network device may perform channel decoding, and output, to the scene audio decoding module, the first bitstream obtained through channel decoding. Then, the scene audio decoding module decodes the first bitstream, to obtain the scene audio signal, and outputs the scene audio signal to the other audio encoding module. Then, the other audio encoding module may encode the scene audio signal, to obtain a second bitstream, and output the second bitstream to the channel encoding module. After performing channel encoding on the second bitstream, the channel encoding module sends the encoded second bitstream to the second electronic device. In this way, the second electronic device may invoke the other audio decoding module to decode the second bitstream obtained through channel decoding, to obtain a reconstructed scene audio signal; and subsequently, may perform audio playback on the reconstructed scene audio signal.

The following describes scene audio signal encoding and decoding processes.

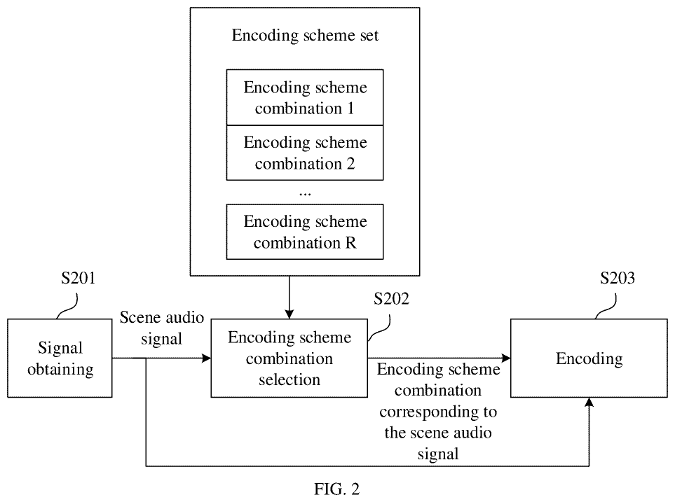

FIG. 2 is a diagram of an example scene audio signal encoding process.

S201: Obtain a scene audio signal.

For example, a to-be-encoded scene audio signal is obtained. The scene audio signal may include an audio signal with C channels. C is a positive integer.

For example, when the scene audio signal is an HOA signal, the HOA signal may be an N1-order HOA signal, namely, B_{m,n}^{σ} in Formula (3) when m is truncated to an N1^{th} item.

For example, the N1-order HOA signal may include an audio signal with C channels. C=(N1+1)². For example, when N1=3, the N1-order HOA signal includes an audio signal with 16 channels; and when N1=4, the N1-order HOA signal includes an audio signal with 25 channels.

For example, the scene audio signal may include one or more frames.

S202: Determine an encoding scheme combination corresponding to the scene audio signal from an encoding scheme set, where the encoding scheme set includes a plurality of encoding scheme combinations.

For example, the encoding scheme set may be pre-established, and the encoding scheme set is stored on an encoder side. The encoding scheme set may include the plurality of encoding scheme combinations, and each encoding scheme combination may include encoding schemes corresponding to a plurality of channels. A specific process of establishing the encoding scheme set is described below. A quantity of encoding scheme combinations included in the encoding scheme set may be represented by R (R is a positive integer).

In this way, after obtaining the to-be-encoded scene audio signal, the encoder side may search the encoding scheme set for the encoding scheme combination corresponding to the scene audio signal. For example, the encoding scheme set may be searched for the encoding scheme combination corresponding to the scene audio signal based on current scene information. The current scene information may include information related to the to-be-encoded scene audio signal, for example, an encoding rate (which may also be referred to as an encoding bit rate) or channel information (for example, a channel quantity or a channel identifier (for example, a channel number)). This is not limited in this disclosure.

For example, one encoding scheme combination in the encoding scheme set may include encoding schemes corresponding to K channels. K is a positive integer.

In a possible manner, encoding schemes corresponding to at least two channels in the encoding schemes corresponding to the K channels are different.

In a possible manner, the encoding schemes corresponding to the K channels are the same.

S203: Encode the scene audio signal based on the encoding scheme combination corresponding to the scene audio signal.

For example, after the encoding scheme combination corresponding to the scene audio signal is determined, the scene audio signal may be encoded based on the encoding scheme combination corresponding to the scene audio signal. For example, the encoding scheme combination corresponding to the scene audio signal includes encoding schemes corresponding to a plurality of channels, and each channel in the scene audio signal may be encoded based on an encoding scheme corresponding to each channel in the encoding scheme combination corresponding to the scene audio signal, to obtain a bitstream of the scene audio signal.

If the scene audio signal includes an audio signal with C channels, the encoding scheme combination corresponding to the scene audio signal includes encoding schemes corresponding to the C channels. In this way, C channels in the scene audio signal may be encoded based on the encoding schemes corresponding to the C channels, to obtain the bitstream of the scene audio signal.

In a possible manner, when the scene audio signal includes a plurality of frames, an encoding scheme combination corresponding to each frame of the scene audio signal may be determined from the encoding scheme set, and then each frame of the scene audio signal is encoded based on the encoding scheme combination corresponding to each frame of the scene audio signal.

In a possible manner, when the scene audio signal includes one frame, an encoding scheme combination corresponding to the frame of the scene audio signal may be determined from the encoding scheme set, and then the plurality of frames of scene audio signals are encoded based on the encoding scheme combination corresponding to the frame of the scene audio signal.

In this way, an encoding scheme combination used for encoding can be quickly determined by querying the pre-established encoding scheme set, thereby saving time consumed throughout an encoding process and improving encoding efficiency.

For scene audio signals in different scenes, an encoding scheme combination applicable to different scenes may be selected from the pre-established encoding scheme set for encoding. Because an encoding scheme combination with good encoding performance may be selected for establishment of the encoding scheme set, this disclosure can ensure encoding performance of a scene audio signal in each scene to some extent, and improve flexibility.

In addition, when encoding schemes corresponding to at least two channels in the encoding schemes that correspond to the plurality of channels and that are included in the encoding scheme combination corresponding to the scene audio signal are different, compared with a case in which encoding is performed based on a single encoding scheme, when encoding is performed based on the encoding scheme combination, an advantage of one encoding scheme in the encoding scheme combination can be used to compensate for a disadvantage of another encoding scheme to some extent, thereby improving encoding performance to some extent.

Still in addition, even if the encoding schemes that correspond to the plurality of channels and that are included in the encoding scheme combination corresponding to the scene audio signal are the same, that is, are all a direct encoding scheme (the signal is encoded, for example, operations such as time-frequency transform, preprocessing, bit allocation, quantization, and entropy encoding may be performed on the signal), compared with an example technology, in this disclosure, a channel quantity of the to-be-encoded audio signal is less. Therefore, an encoding bit rate in this disclosure is lower while achieving same quality.

For example, the encoder side and a decoder side may pre-synchronize the encoding scheme set (correspondingly referred to as a decoding scheme set on the decoder side).

In a possible manner, the encoder side and the decoder side pre-agree on a type of scene information used to determine, from an encoding and decoding scheme set (including the encoding scheme set and the decoding scheme set), an encoding and decoding scheme combination (including an encoding scheme combination and a decoding scheme combination) used for encoding and decoding.

In a possible manner, the encoder side and the decoder side do not pre-agree on a type of scene information used to determine, from an encoding and decoding scheme set, an encoding and decoding scheme combination used for encoding and decoding. In this case, the encoder side may encode a preset identifier (for ease of distinguishing, the preset identifier is referred to as a first preset identifier subsequently). The first preset identifier may be used to indicate the type of the scene information. In this way, the first preset identifier is transmitted to the decoder side, so that the decoder side determines, from the decoding scheme set, a decoding scheme combination used for decoding.

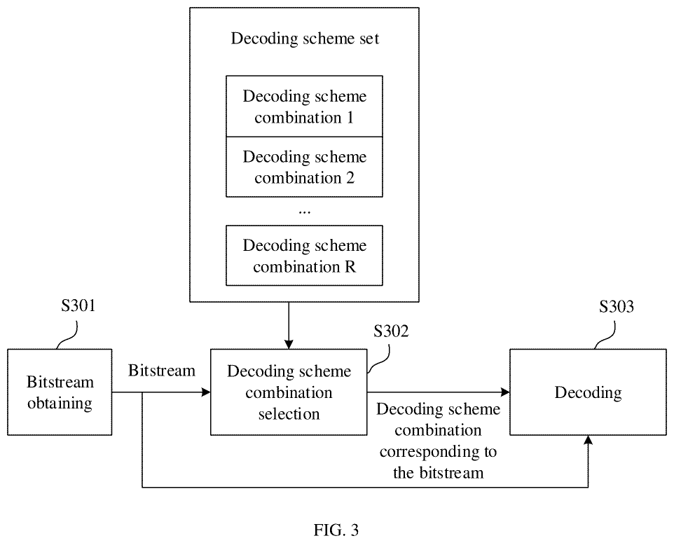

FIG. 3 is a diagram of an example scene audio decoding process. The embodiment in FIG. 3 is a decoding process corresponding to the encoding process in the embodiment in FIG. 2.

S301: Receive a bitstream.

S302: Determine a decoding scheme combination corresponding to the bitstream from a decoding scheme set, where the decoding scheme set includes a plurality of decoding scheme combinations.

For example, the decoding scheme set may include the plurality of decoding scheme combinations, and each decoding scheme combination may include decoding schemes corresponding to a plurality of channels. A quantity of decoding scheme combinations included in the decoding scheme set may be represented by R (R is a positive integer).

For example, after the bitstream is received, the decoding scheme combination corresponding to the bitstream may be determined from the decoding scheme set. For example, the decoding scheme set may be searched for the decoding scheme combination corresponding to the bitstream based on current scene information. The current scene information may include information related to a to-be-decoded scene audio signal, for example, a decoding rate (which may also be referred to as a decoding bit rate) or channel information (for example, a channel quantity or a channel identifier (for example, a channel number)). This is not limited in this disclosure.

In a possible manner, when an encoder side and a decoder side pre-agree on a type of scene information used to determine an encoding and decoding scheme combination used for encoding and decoding from an encoding and decoding scheme set, the decoder side may search the decoding scheme set for the decoding scheme combination corresponding to the bitstream based on the pre-agreed type of the current scene information.

In a possible manner, when an encoder side and a decoder side do not pre-agree on a type of scene information used to determine an encoding and decoding scheme combination used for encoding and decoding from an encoding and decoding scheme set, the decoder side may parse out a first preset identifier from the bitstream; and then search the decoding scheme set for the decoding scheme combination corresponding to the bitstream based on current scene information corresponding to the first preset identifier.

S303: Decode the bitstream based on the decoding scheme combination corresponding to the bitstream, to obtain a reconstructed scene audio signal.

For example, the reconstructed scene audio signal may include an audio signal with C channels. C is a positive integer.

For example, when the reconstructed scene audio signal is an N1-order HOA signal, C=(N1+1)². For example, when N1=3, the N1-order HOA signal includes a reconstructed audio signal with 16 channels; and when N1=4, the N1-order HOA signal includes a reconstructed audio signal with 25 channels.

For example, after the decoding scheme combination corresponding to the bitstream is determined, the bitstream may be decoded based on the decoding scheme combination corresponding to the bitstream, to obtain the reconstructed scene audio signal. For example, the decoding scheme combination corresponding to the bitstream includes decoding schemes corresponding to a plurality of channels, and each channel may be decoded based on the bitstream and a decoding scheme corresponding to each channel in the decoding scheme combination corresponding to the bitstream, to obtain the reconstructed scene audio signal.

If the reconstructed scene audio signal includes a reconstructed audio signal with C channels, the decoding scheme combination corresponding to the bitstream includes decoding schemes corresponding to the C channels. In this way, the C channels may be decoded based on the bitstream and the decoding schemes corresponding to the C channels, to obtain a reconstructed audio signal including the C channels. The reconstructed audio signal with the C channels may form the reconstructed scene audio signal.

For example, the bitstream includes one or more frames, and correspondingly, the reconstructed scene audio signal may include one or more frames.

In a possible manner, when the bitstream includes a plurality of frames, a decoding scheme combination corresponding to each frame of the bitstream may be determined from the decoding scheme set; and then each frame of the bitstream is decoded based on the decoding scheme combination corresponding to each frame of the bitstream, to obtain each frame of reconstructed scene audio signal.

In a possible manner, when the bitstream includes a plurality of frames, a decoding scheme combination corresponding to one frame of the bitstream may be determined from the decoding scheme set; and then the plurality of frames of bitstreams are decoded based on the decoding scheme combination corresponding to the frame of the bitstream, to obtain a plurality of frames of reconstructed scene audio signals.

It should be understood that, when the encoder side encodes one frame of the scene audio signal based on a corresponding encoding scheme combination, the decoder side decodes each frame of the bitstream based on a corresponding decoding scheme combination. When the encoder side encodes a plurality of frames of scene audio signals based on a same encoding scheme combination, the decoder side decodes a plurality of frames of bitstreams based on a same decoding scheme combination.

In this way, a decoding scheme combination used for decoding can be quickly determined by querying a pre-established decoding scheme set, thereby saving time consumed in an entire decoding process and improving decoding efficiency.

For different scene audio signals, a decoding scheme combination applicable to different scenes may be selected from the pre-established decoding scheme set for decoding. Because an encoding scheme combination (a decoding scheme combination corresponds to the encoding scheme combination) with good encoding performance may be selected for establishment of the encoding scheme set, this disclosure can ensure audio reconstruction quality of different scenes to some extent, and improve flexibility.

The following describes a process of establishing the encoding scheme set based on a channel in an N2-order HOA signal. A channel quantity K of the N2-order HOA signal is equal to the square of (N2+1).

In a possible manner, different encoding scheme combinations may be established for different encoding rates. In this way, a plurality of encoding scheme combinations may be established for a plurality of encoding rates. The plurality of encoding scheme combinations may form an encoding scheme set.

In a possible manner, an encoding scheme combination corresponding to one channel quantity (there is one value of N2) is established for one encoding rate. N2 is greater than or equal to N1, and K is greater than or equal to C.

For example, each encoding scheme combination in the encoding scheme set may include encoding schemes corresponding to K channels. In a possible manner, encoding schemes corresponding to at least two channels in the encoding schemes corresponding to the K channels are different. In a possible manner, the encoding schemes corresponding to the K channels are the same. This is not limited in this disclosure.

For example, a decoding scheme corresponding to one channel may include at least one of the following: a first decoding scheme, a second decoding scheme, or a third decoding scheme, the first decoding scheme is decoding a signal, the second decoding scheme is a spatial decoding scheme, and the third decoding scheme is a decoding scheme other than the first decoding scheme and the second decoding scheme.

For example, the first encoding scheme may be encoding a signal performing operations such as time-frequency transform, preprocessing, bit allocation, quantization, and entropy encoding on the signal. The first encoding scheme may also be referred to as a direct encoding scheme.

For example, the second encoding scheme may be the spatial encoding scheme, and the spatial encoding scheme is encoding attribute information that is of a target virtual speaker and that is determined based on the scene audio signal. A process of determining the attribute information of the target virtual speaker based on the scene audio signal is described below.

For example, the third encoding scheme may include one or more encoding schemes other than the first encoding scheme and the second encoding scheme.

In a possible manner, the third encoding scheme is channel copy (or HOA copy) encoding. Optionally, the third encoding scheme is a de-correlation encoding scheme. It should be understood that a quantity and types of encoding schemes included in the third encoding scheme are not limited in this disclosure.

TABLE 1

| | Encoding | | | | |
|---|---|---|---|---|---|
| | scheme | | | | |
| | combination 1 | Encoding | Encoding | Encoding | Encoding |
| | (256 kilobits | scheme | scheme | scheme | scheme |
| | per second | combination 2 | combination 3 | combination 4 | combination 5 |
| Channel | (kbps) | (384 kbps) | (512 kbps) | (768 kbps) | (768 kbps) |
| 1 | Direct | Direct | Direct | Direct | Direct |
| | encoding | encoding | encoding | encoding | encoding |
| | scheme | scheme | scheme | scheme | scheme |
| 2 | Direct | Direct | Direct | Direct | Direct |
| | encoding | encoding | encoding | encoding | encoding |
| | scheme | scheme | scheme | scheme | scheme |
| 3 | Direct | Direct | Direct | Direct | Direct |
| | encoding | encoding | encoding | encoding | encoding |
| | scheme | scheme | scheme | scheme | scheme |
| 4 | Direct | Direct | Direct | Direct | Direct |
| | encoding | encoding | encoding | encoding | encoding |
| | scheme | scheme | scheme | scheme | scheme |
| 5 | De-correlation | De-correlation | Direct | Direct | Direct |
| | encoding | encoding | encoding | encoding | encoding |
| | scheme | scheme | scheme | scheme | scheme |
| 6 | Spatial | Spatial | Direct | Direct | Direct |
| | encoding | encoding | encoding | encoding | encoding |
| | scheme | scheme | scheme | scheme | scheme |
| 7 | Spatial | Spatial | Spatial | Direct | Spatial |
| | encoding | encoding | encoding | encoding | encoding |
| | scheme | scheme | scheme | scheme | scheme |
| 8 | Spatial | Spatial | Spatial | Direct | Direct |
| | encoding | encoding | encoding | encoding | encoding |
| | scheme | scheme | scheme | scheme | scheme |
| 9 | De-correlation | De-correlation | Spatial | Direct | Direct |
| | encoding | encoding | encoding | encoding | encoding |
| | scheme | scheme | scheme | scheme | scheme |
| 10 | De-correlation | De-correlation | De-correlation | De-correlation | De-correlation |
| | encoding | encoding | encoding | encoding | encoding |
| | scheme | scheme | scheme | scheme | scheme |
| 11 | Spatial | Spatial | Spatial | Spatial | Spatial |
| | encoding | encoding | encoding | encoding | encoding |
| | scheme | scheme | scheme | scheme | scheme |
| 12 | Spatial | Spatial | Spatial | Spatial | Spatial |
| | encoding | encoding | encoding | encoding | encoding |
| | scheme | scheme | scheme | scheme | scheme |
| 13 | Spatial | Spatial | Spatial | Spatial | Spatial |
| | encoding | encoding | encoding | encoding | encoding |
| | scheme | scheme | scheme | scheme | scheme |
| 14 | Spatial | Spatial | Spatial | Spatial | Spatial |
| | encoding | encoding | encoding | encoding | encoding |
| | scheme | scheme | scheme | scheme | scheme |
| 15 | Spatial | Spatial | Spatial | Spatial | Spatial |
| | encoding | encoding | encoding | encoding | encoding |
| | scheme | scheme | scheme | scheme | scheme |
| 16 | De-correlation | De-correlation | De-correlation | De-correlation | De-correlation |
| | encoding | encoding | encoding | encoding | encoding |
| | scheme | scheme | scheme | scheme | scheme |

If N2=3, K=16. Each encoding scheme combination in the encoding scheme set may include encoding schemes corresponding to 16 channels (the channel 1 to the channel 16). As shown in Table 1, the encoding scheme combination 1 may be established for the encoding rate of 256 kbps; the encoding scheme combination 2 is established for the encoding rate of 384 kbps; the encoding scheme combination 3 is established for the encoding rate of 512 kbps; and the encoding scheme combination 4 and the encoding scheme combination 5 are established for the encoding rate of 768 kbps.

It should be understood that Table 1 is an example, and a corresponding encoding scheme combination may be further set for another encoding rate. This is not limited in this disclosure.

It should be understood that Table 1 is an example, and another encoding scheme combination may be further established for the encoding rates 256 kbps, 384 kbps, 512 kbps, and 768 kbps. This is not limited in this disclosure.

As shown in Table 1, the encoding scheme combination 1 includes encoding schemes corresponding to the 16 channels. For example, encoding schemes corresponding to the channel 1 to the channel 4 in the encoding scheme combination 1 are the direct encoding scheme; encoding schemes corresponding to the channel 5, the channel 9, the channel 10, and the channel 16 in the encoding scheme combination 1 are the de-correlation encoding scheme; and encoding schemes corresponding to the channel 6 to the channel 8 and the channel 11 to the channel 15 in the encoding scheme combination 1 are the spatial encoding scheme. Descriptions of the other encoding scheme combinations in Table 1 are similar, and details are not described herein again. Correspondingly, a decoding scheme set stored on the decoder side may be shown in Table 2:

TABLE 2

| | Decoding | Decoding | Decoding | Decoding | Decoding |
|---|---|---|---|---|---|
| | scheme | scheme | scheme | scheme | scheme |
| | combination 1 | combination 2 | combination 3 | combination 4 | combination 5 |
| Channel | (256 kbps) | (384 kbps) | (512 kbps) | (768 kbps) | (768 kbps) |
| 1 | Direct | Direct | Direct | Direct | Direct |
| | decoding | decoding | decoding | decoding | decoding |
| | scheme | scheme | scheme | scheme | scheme |
| 2 | Direct | Direct | Direct | Direct | Direct |
| | decoding | decoding | decoding | decoding | decoding |
| | scheme | scheme | scheme | scheme | scheme |
| 3 | Direct | Direct | Direct | Direct | Direct |
| | decoding | decoding | decoding | decoding | decoding |
| | scheme | scheme | scheme | scheme | scheme |
| 4 | Direct | Direct | Direct | Direct | Direct |
| | decoding | decoding | decoding | decoding | decoding |
| | scheme | scheme | scheme | scheme | scheme |
| 5 | De-correlation | De-correlation | Direct | Direct | Direct |
| | decoding | decoding | decoding | decoding | decoding |
| | scheme | scheme | scheme | scheme | scheme |
| 6 | Spatial | Spatial | Direct | Direct | Direct |
| | decoding | decoding | decoding | decoding | decoding |
| | scheme | scheme | scheme | scheme | scheme |
| 7 | Spatial | Spatial | Spatial | Direct | Spatial |
| | decoding | decoding | decoding | decoding | decoding |
| | scheme | scheme | scheme | scheme | scheme |
| 8 | Spatial | Spatial | Spatial | Direct | Direct |
| | decoding | decoding | decoding | decoding | decoding |
| | scheme | scheme | scheme | scheme | scheme |
| 9 | De-correlation | De-correlation | Spatial | Direct | Direct |
| | decoding | decoding | decoding | decoding | decoding |
| | scheme | scheme | scheme | scheme | scheme |
| 10 | De-correlation | De-correlation | De-correlation | De-correlation | De-correlation |
| | decoding | decoding | decoding | decoding | decoding |
| | scheme | scheme | scheme | scheme | scheme |
| 11 | Spatial | Spatial | Spatial | Spatial | Spatial |
| | decoding | decoding | decoding | decoding | decoding |
| | scheme | scheme | scheme | scheme | scheme |
| 12 | Spatial | Spatial | Spatial | Spatial | Spatial |
| | decoding | decoding | decoding | decoding | decoding |
| | scheme | scheme | scheme | scheme | scheme |
| 13 | Spatial | Spatial | Spatial | Spatial | Spatial |
| | decoding | decoding | decoding | decoding | decoding |
| | scheme | scheme | scheme | scheme | scheme |
| 14 | Spatial | Spatial | Spatial | Spatial | Spatial |
| | decoding | decoding | decoding | decoding | decoding |
| | scheme | scheme | scheme | scheme | scheme |
| 15 | Spatial | Spatial | Spatial | Spatial | Spatial |
| | decoding | decoding | decoding | decoding | decoding |
| | scheme | scheme | scheme | scheme | scheme |
| 16 | De-correlation | De-correlation | De-correlation | De-correlation | De-correlation |
| | decoding | decoding | decoding | decoding | decoding |
| | scheme | scheme | scheme | scheme | scheme |

The following describes a process of establishing the encoding scheme set based on a channel in an N2-order HOA signal. A channel quantity K of the N2-order HOA signal is equal to the square of (N2+1).

In a possible manner, different encoding scheme combinations may be established for different encoding rates. In this way, a plurality of encoding scheme combinations may be established for a plurality of encoding rates. The plurality of encoding scheme combinations may form an encoding scheme set.

In a possible manner, encoding scheme combinations corresponding to a plurality of channel quantities (that is, there are a plurality of values of N2) are established for one encoding rate.

For example, each encoding scheme combination in the encoding scheme set may include encoding schemes corresponding to K channels. In a possible manner, encoding schemes corresponding to at least two channels in the encoding schemes corresponding to the K channels are different. In a possible manner, the encoding schemes corresponding to the K channels are the same. This is not limited in this disclosure.

For example, a decoding scheme corresponding to one channel may include at least one of the following: a first decoding scheme, a second decoding scheme, or a third decoding scheme, the first decoding scheme is decoding a signal, the second decoding scheme is a spatial decoding scheme, and the third decoding scheme is a decoding scheme other than the first decoding scheme and the second decoding scheme.

For example, the third encoding scheme may include one or more encoding schemes other than the first encoding scheme and the second encoding scheme.

In a possible manner, the third encoding scheme is channel copy (or HOA copy) encoding. Optionally, the third encoding scheme is a de-correlation encoding scheme. It should be understood that a quantity and types of encoding schemes included in the third encoding scheme are not limited in this disclosure.

TABLE 3

| | Encoding scheme | Encoding scheme | Encoding scheme |
|---|---|---|---|
| | combination 1 | combination 2 | combination 3 |
| Channel | (256 kbps) | (256 kbps) | (256 kbps) |
| 1 | Direct encoding scheme | Direct encoding scheme | Direct encoding scheme |
| 2 | Direct encoding scheme | De-correlation encoding | De-correlation encoding |
| | | scheme | scheme |
| 3 | Direct encoding scheme | De-correlation encoding | Spatial encoding scheme |
| | | scheme | |
| 4 | Direct encoding scheme | De-correlation encoding | De-correlation encoding |
| | | scheme | scheme |
| 5 | De-correlation encoding | De-correlation encoding | |
| | scheme | scheme | |
| 6 | Spatial encoding scheme | De-correlation encoding | |
| | | scheme | |
| 7 | Spatial encoding scheme | De-correlation encoding | |
| | | scheme | |
| 8 | Spatial encoding scheme | De-correlation encoding | |
| | | scheme | |
| 9 | De-correlation encoding | De-correlation encoding | |
| | scheme | scheme | |
| 10 | De-correlation encoding | | |
| | scheme | | |
| 11 | Spatial encoding scheme | | |
| 12 | Spatial encoding scheme | | |
| 13 | Spatial encoding scheme | | |
| 14 | Spatial encoding scheme | | |
| 15 | Spatial encoding scheme | | |
| 16 | De-correlation encoding | | |
| | scheme | | |

If N2=3, K=16. Each encoding scheme combination in the encoding scheme set may include encoding schemes corresponding to 16 channels (the channel 1 to the channel 16). As shown in Table 3, the encoding scheme combination 1 may be established for the encoding rate of 256 kbps. As shown in Table 4, an encoding scheme combination 4 may be established for an encoding rate of 384 kbps.

If N2=2, K=9. Each encoding scheme combination in the encoding scheme set may include encoding schemes corresponding to nine channels (the channel 1 to the channel 9). As shown in Table 3, the encoding scheme combination 2 may be established for the encoding rate of 256 kbps. As shown in Table 4, an encoding scheme combination 5 may be established for an encoding rate of 384 kbps.

If N2=1, K=4. Each encoding scheme combination in the encoding scheme set may include encoding schemes corresponding to 4 channels (the channel 1 to the channel 4). As shown in Table 3, the encoding scheme combination 3 may be established for the encoding rate of 256 kbps. As shown in Table 4, an encoding scheme combination 6 may be established for an encoding rate of 384 kbps.

It should be understood that Table 3 and Table 4 are examples, and a corresponding encoding scheme combination may be further set for another encoding rate. This is not limited in this disclosure.

It should be understood that Table 3 and Table 4 are examples. When N2 is separately equal to 1, 2, or 3, another encoding scheme combination may be further established for each of the encoding rates of 256 kbps and 384 kbps. This is not limited in this disclosure.

As shown in Table 3, the encoding scheme combination 2 includes encoding schemes corresponding to nine channels. For example, an encoding scheme corresponding to the channel 1 in the encoding scheme combination 2 is the direct encoding scheme, and encoding schemes corresponding to the channel 2 to the channel 9 in the encoding scheme combination 1 are the de-correlation encoding scheme. Descriptions of the other encoding scheme combinations in Table 3 and Table 4 are similar, and details are not described herein again.

TABLE 4

| | Encoding scheme | Encoding scheme | Encoding scheme |
|---|---|---|---|
| | combination 4 | combination 5 | combination 6 |
| Channel | (384 kbps) | (384 kbps) | (384 kbps) |
| 1 | Direct encoding scheme | Direct encoding | Direct encoding scheme |
| | | scheme | |
| 2 | Direct encoding scheme | Direct encoding | Direct encoding scheme |
| | | scheme | |
| 3 | Direct encoding scheme | Direct encoding | Direct encoding scheme |
| | | scheme | |
| 4 | Direct encoding scheme | Direct encoding | Direct encoding scheme |
| | | scheme | |
| 5 | De-correlation encoding | Direct encoding | |
| | scheme | scheme | |
| 6 | Spatial encoding scheme | Direct encoding | |
| | | scheme | |
| 7 | Spatial encoding scheme | Spatial encoding | |
| | | scheme | |
| 8 | Spatial encoding scheme | Spatial encoding | |
| | | scheme | |
| 9 | De-correlation encoding | Spatial encoding | |
| | scheme | scheme | |
| 10 | De-correlation encoding | | |
| | scheme | | |
| 11 | Spatial encoding scheme | | |
| 12 | Spatial encoding scheme | | |
| 13 | Spatial encoding scheme | | |
| 14 | Spatial encoding scheme | | |
| 15 | Spatial encoding scheme | | |
| 16 | De-correlation encoding | | |
| | scheme | | |

Correspondingly, a decoding scheme set stored on the decoder side may be shown in Table 5 and Table 6.

TABLE 5

| | Decoding scheme | Decoding scheme | Decoding scheme |
|---|---|---|---|
| | combination 1 | combination 2 | combination 3 |
| Channel | (256 kbps) | (256 kbps) | (256 kbps) |
| 1 | Direct decoding scheme | Direct decoding scheme | Direct decoding scheme |
| 2 | Direct decoding scheme | De-correlation decoding | De-correlation decoding |
| | | scheme | scheme |
| 3 | Direct decoding scheme | De-correlation decoding | Spatial decoding scheme |
| | | scheme | |
| 4 | Direct decoding scheme | De-correlation decoding | De-correlation decoding |
| | | scheme | scheme |
| 5 | De-correlation decoding | De-correlation decoding | |
| | scheme | scheme | |
| 6 | Spatial decoding scheme | De-correlation decoding | |
| | | scheme | |
| 7 | Spatial decoding scheme | De-correlation decoding | |
| | | scheme | |
| 8 | Spatial decoding scheme | De-correlation decoding | |
| | | scheme | |
| 9 | De-correlation decoding | De-correlation decoding | |
| | scheme | scheme | |
| 10 | De-correlation decoding | | |
| | scheme | | |
| 11 | Spatial decoding scheme | | |
| 12 | Spatial decoding scheme | | |
| 13 | Spatial decoding scheme | | |
| 14 | Spatial decoding scheme | | |
| 15 | Spatial decoding scheme | | |
| 16 | De-correlation decoding | | |
| | scheme | | |

TABLE 6

| | Decoding scheme | Decoding scheme | Decoding scheme |
|---|---|---|---|
| | combination 4 | combination 5 | combination 6 |
| Channel | (384 kbps) | (384 kbps) | (384 kbps) |
| 1 | Direct decoding scheme | Direct decoding | Direct decoding scheme |
| | | scheme | |
| 2 | Direct decoding scheme | Direct decoding | Direct decoding scheme |
| | | scheme | |
| 3 | Direct decoding scheme | Direct decoding | Direct decoding scheme |
| | | scheme | |
| 4 | Direct decoding scheme | Direct decoding | Direct decoding scheme |
| | | scheme | |
| 5 | De-correlation decoding | Direct decoding | |
| | scheme | scheme | |
| 6 | Spatial decoding scheme | Direct decoding | |
| | | scheme | |
| 7 | Spatial decoding scheme | Spatial decoding | |
| | | scheme | |
| 8 | Spatial decoding scheme | Spatial decoding | |
| | | scheme | |
| 9 | De-correlation decoding | Spatial decoding | |
| | scheme | scheme | |
| 10 | De-correlation decoding | | |
| | scheme | | |
| 11 | Spatial decoding scheme | | |
| 12 | Spatial decoding scheme | | |
| 13 | Spatial decoding scheme | | |
| 14 | Spatial decoding scheme | | |
| 15 | Spatial decoding scheme | | |
| 16 | De-correlation decoding | | |
| | scheme | | |

The following describes a process of establishing the encoding scheme set based on a channel in an N2-order HOA signal. A channel quantity K of the N2-order HOA signal is equal to the square of (N2+1).

In a possible manner, when different values are taken for N2, different encoding scheme combinations may be established. In this way, a plurality of encoding scheme combinations may be established for a plurality of values of N2, and the plurality of encoding scheme combinations may form an encoding scheme set.

For example, each encoding scheme combination in the encoding scheme set may include encoding schemes corresponding to K channels. In a possible manner, encoding schemes corresponding to at least two channels in the encoding schemes corresponding to the K channels are different. In a possible manner, the encoding schemes corresponding to the K channels are the same. This is not limited in this disclosure.

For example, a decoding scheme corresponding to one channel may include at least one of the following: a first decoding scheme, a second decoding scheme, or a third decoding scheme, the first decoding scheme is decoding a signal, the second decoding scheme is a spatial decoding scheme, and the third decoding scheme is a decoding scheme other than the first decoding scheme and the second decoding scheme.

For example, the third encoding scheme may include one or more encoding schemes other than the first encoding scheme and the second encoding scheme.

In a possible manner, the third encoding scheme is channel copy (or HOA copy) encoding. Optionally, the third encoding scheme is a de-correlation encoding scheme. It should be understood that a quantity and types of encoding schemes included in the third encoding scheme are not limited in this disclosure.

TABLE 7

| | Encoding scheme | Encoding scheme | Encoding scheme |
|---|---|---|---|
| Channel | combination 1 | combination 2 | combination 3 |
| 1 | Direct encoding scheme | Direct encoding scheme | Direct encoding scheme |
| 2 | Direct encoding scheme | De-correlation encoding | De-correlation encoding |
| | | scheme | scheme |
| 3 | Direct encoding scheme | De-correlation encoding | Spatial encoding scheme |
| | | scheme | |
| 4 | Direct encoding scheme | De-correlation encoding | De-correlation encoding |
| | | scheme | scheme |
| 5 | De-correlation encoding | De-correlation encoding | |
| | scheme | scheme | |
| 6 | Spatial encoding scheme | De-correlation encoding | |
| | | scheme | |
| 7 | Spatial encoding scheme | De-correlation encoding | |
| | | scheme | |
| 8 | Spatial encoding scheme | De-correlation encoding | |
| | | scheme | |
| 9 | De-correlation encoding | De-correlation encoding | |
| | scheme | scheme | |
| 10 | De-correlation encoding | | |
| | scheme | | |
| 11 | Spatial encoding scheme | | |
| 12 | Spatial encoding scheme | | |
| 13 | Spatial encoding scheme | | |
| 14 | Spatial encoding scheme | | |
| 15 | Spatial encoding scheme | | |
| 16 | De-correlation encoding | | |
| | scheme | | |

If N2=3, K=16. One encoding scheme combination in the encoding scheme set may include encoding schemes corresponding to 16 channels (the channel 1 to the channel 16). For details, refer to the encoding scheme combination 1 in Table 7.

If N2=2, K=9. One encoding scheme combination in the encoding scheme set may include encoding schemes corresponding to nine channels (the channel 1 to the channel 9). For details, refer to the encoding scheme combination 2 in Table 7.

If N2=1, K=4. One encoding scheme combination in the encoding scheme set may include encoding schemes corresponding to four channels (the channel 1 to the channel 4). For details, refer to the encoding scheme combination 3 in Table 7.

It should be understood that Table 7 is an example. When N2 is separately equal to 1,2, or 3, different encoding scheme combinations may be further set. This is not limited in this disclosure.

It should be understood that Table 7 is an example, and a corresponding encoding scheme combination may be further established for another value of N2. This is not limited in this disclosure.

As shown in Table 7, the encoding scheme combination 2 includes encoding schemes corresponding to nine channels. For example, an encoding scheme corresponding to the channel 1 in the encoding scheme combination 2 is the direct encoding scheme, and encoding schemes corresponding to the channel 2 to the channel 9 in the encoding scheme combination 1 are the de-correlation encoding scheme. Descriptions of the other encoding scheme combinations in Table 7 are similar, and details are not described herein again.

Correspondingly, a decoding scheme set stored on the decoder side may be shown in Table 8.

TABLE 8

| | Decoding scheme | Decoding scheme | Decoding scheme |
|---|---|---|---|
| Channel | combination 1 | combination 2 | combination 3 |
| 1 | Direct decoding scheme | Direct decoding scheme | Direct decoding scheme |
| 2 | Direct decoding scheme | De-correlation decoding | De-correlation decoding |
| | | scheme | scheme |
| 3 | Direct decoding scheme | De-correlation decoding | Spatial decoding scheme |
| | | scheme | |
| 4 | Direct decoding scheme | De-correlation decoding | De-correlation decoding |
| | | scheme | scheme |
| 5 | De-correlation decoding | De-correlation decoding | |
| | scheme | scheme | |
| 6 | Spatial decoding scheme | De-correlation decoding | |
| | | scheme | |
| 7 | Spatial decoding scheme | De-correlation decoding | |
| | | scheme | |
| 8 | Spatial decoding scheme | De-correlation decoding | |
| | | scheme | |
| 9 | De-correlation decoding | De-correlation decoding | |
| | scheme | scheme | |
| 10 | De-correlation decoding | | |
| | scheme | | |
| 11 | Spatial decoding scheme | | |
| 12 | Spatial decoding scheme | | |
| 13 | Spatial decoding scheme | | |
| 14 | Spatial decoding scheme | | |
| 15 | Spatial decoding scheme | | |
| 16 | De-correlation decoding | | |
| | scheme | | |

For example, a plurality of encoding schemes may be further set for a plurality of bands of each channel in each encoding scheme combination.

For example, an audio signal with one channel may be divided into Y bands. Y may be set according to a requirement. This is not limited in this disclosure.

For example, Y=2. The audio signal with one channel may include a band 1 and a band 2. A frequency of the band 1 is less than a first frequency threshold, and a frequency of the band 2 is greater than the first frequency threshold.

For example, Y=3. The audio signal with one channel may include a band 1, a band 2,and a band 3. A frequency of the band 1 is less than a first frequency threshold, a frequency of the band 2 is greater than the first frequency threshold and less than a second frequency threshold, and a frequency of the band 3 is greater than the second frequency threshold.

It should be noted that for different channels, a quantity Y of bands may be different, and thresholds used for division into bands may also be different. This is not limited in this disclosure. The first frequency threshold and the second frequency threshold may be set according to a requirement. Details are not described herein again.

For example, Y=2, the band 1 in the channel corresponds to the first encoding scheme, and the band 2 in the channel corresponds to the third encoding scheme. Alternatively, the band 1 in the channel corresponds to the first encoding scheme, and the band 2 in the channel corresponds to the second encoding scheme.

For example, Y=3, the band 1 in the channel corresponds to the first encoding scheme, the band 2 in the channel corresponds to the second encoding scheme, and the band 3 in the channel corresponds to the third encoding scheme.

The following describes scene audio signal encoding and decoding processes by using the encoding scheme set in Table 1 and the decoding scheme set in Table 2 as examples. An example in which a to-be-encoded scene audio signal is an N1-order HOA signal is used for description.

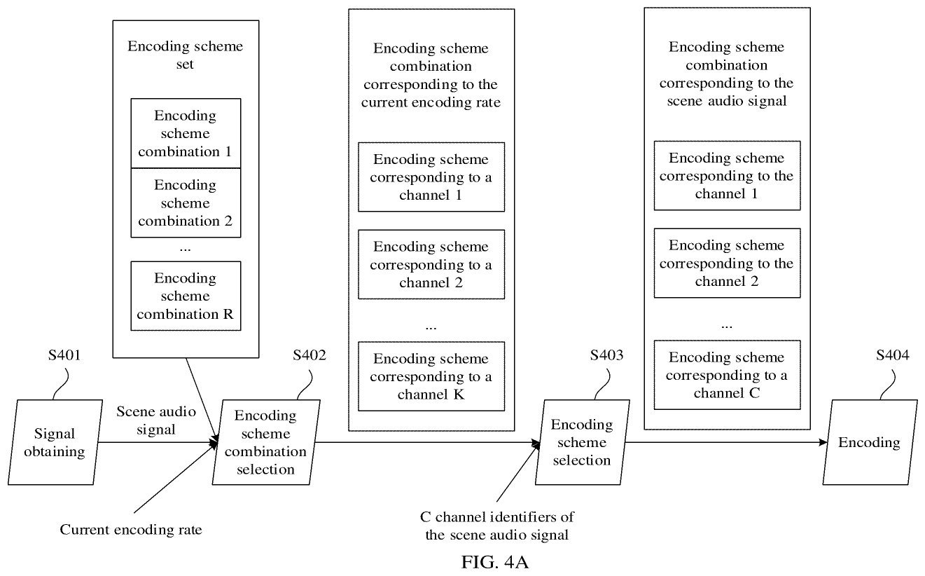

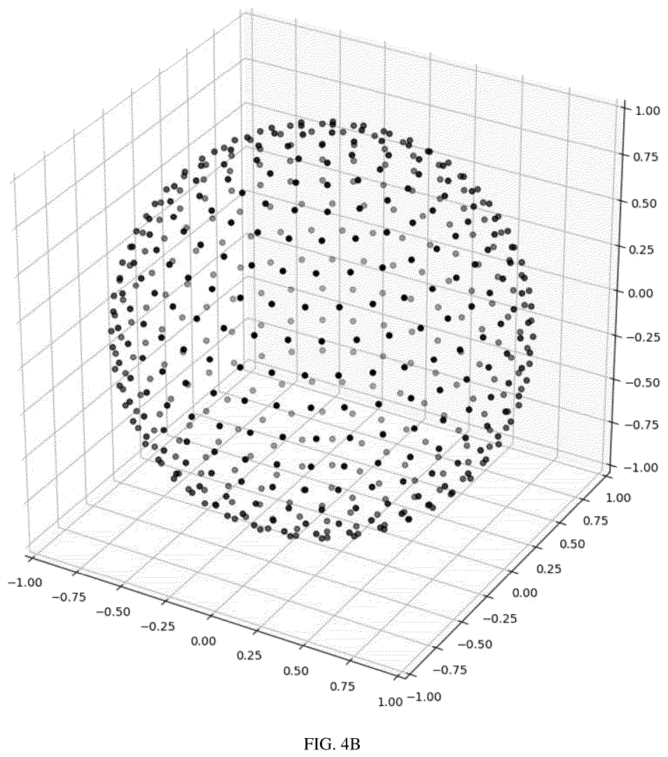

FIG. 4A is a diagram of an example scene audio signal encoding process.

S401: Obtain a scene audio signal.

For example, the scene audio signal is an N1-order HOA signal, the N1-order HOA signal includes an audio signal with C channels, and C is equal to the square of (N1+1).

In a possible manner, an encoding scheme set may be searched for an encoding scheme combination corresponding to the scene audio signal based on a current encoding rate. For details, refer to S402 and S403.

S402: Search the encoding scheme set for an encoding scheme combination corresponding to the current encoding rate.

For example, the encoding scheme set in Table 1 may be searched for the encoding scheme combination corresponding to the current encoding rate based on the current encoding rate.

For example, if the current encoding rate is 256 kbps, it is found, from the encoding scheme set in Table 1, that the encoding scheme combination corresponding to the current encoding rate is the encoding scheme combination 1.

For example, if the current encoding rate is 384 kbps, it is found, from the encoding scheme set in Table 1, that the encoding scheme combination corresponding to the current encoding rate is the encoding scheme combination 2.

For example, if the current encoding rate is 512 kbps, it is found, from the encoding scheme set in Table 1, that the encoding scheme combination corresponding to the current encoding rate is the encoding scheme combination 3.

For example, if the current encoding rate is 768 kbps, it is found, from the encoding scheme set in Table 1, that the encoding scheme combination corresponding to the current encoding rate is the encoding scheme combination 4 or the encoding scheme combination 5.

For example, the encoding scheme combination corresponding to the current encoding rate may include encoding schemes corresponding to K channels. K is greater than or equal to C.

S403: Select encoding schemes corresponding to the C channels in the scene audio signal from the encoding scheme combination corresponding to the current encoding rate, to form the encoding scheme combination corresponding to the scene audio signal.

For example, when K is greater than C, the encoding schemes corresponding to the C channels in the scene audio signal may be selected from the encoding scheme combination corresponding to the current encoding rate, to form the encoding scheme combination corresponding to the scene audio signal. For example, C target channels that are in K channels in Table 1 and that correspond to the C channels in the scene audio signal may be determined based on channel identifiers of the K channels in Table 1 and channel identifiers of the C channels in the scene audio signal; and then encoding schemes corresponding to the C target channels are selected from Table 1, to form the encoding scheme combination corresponding to the scene audio signal.

For example, when an identification manner (for example, a channel number allocation manner) of the K channels in Table 1 is the same as an identification manner of the C channels in the scene audio signal, a combination of encoding schemes corresponding to first C channels may be selected from the encoding scheme combination corresponding to the current encoding rate, to form the encoding scheme combination corresponding to the scene audio signal.

For example, if K=16 and C=9, encoding schemes corresponding to first nine channels may be selected from the encoding scheme combination corresponding to the current encoding rate, to form the encoding scheme combination corresponding to the scene audio signal.

For example, if K=16 and C=4, encoding schemes corresponding to first four channels may be selected from the encoding scheme combination corresponding to the current encoding rate, to form the encoding scheme combination corresponding to the scene audio signal.

For example, if K=16 and C=1, an encoding scheme corresponding to a first channel may be selected from the encoding scheme combination corresponding to the current encoding rate, to form the encoding scheme combination corresponding to the scene audio signal.

For example, when K=C in Table 1, the encoding scheme combination corresponding to the current encoding rate is the encoding scheme combination corresponding to the scene audio signal.

S404: Encode the C channels in the scene audio signal based on the encoding schemes corresponding to the C channels, where C is a positive integer.

For example, for a channel, when an encoding scheme corresponding to the channel is a first encoding scheme (a direct encoding scheme), operations such as time-frequency transform, preprocessing, bit allocation, quantization, and entropy encoding may be performed on an audio signal with the channel, to obtain encoded data of the audio signal with the channel.

For example, for a channel, when an encoding scheme corresponding to the channel is a second encoding scheme (a spatial encoding scheme), attribute information of a target virtual speaker may be determined based on the scene audio signal, and the attribute information of the target virtual speaker is encoded.

For example, the virtual speaker is a speaker that is virtual, and is not a speaker that actually exists.

For example, it can be learned, based on the foregoing descriptions, that the scene audio signal may be expressed through superimposition of a plurality of plane waves, and further, a target virtual speaker used to simulate a sound source in the scene audio signal may be determined. In this way, in a subsequent decoding process, a virtual speaker signal corresponding to the target virtual speaker is used to reconstruct the scene audio signal.

In a possible manner, a plurality of candidate virtual speakers at different locations may be disposed on a spherical surface; and then, a target virtual speaker whose location matches a location of the sound source in the scene audio signal may be selected from the plurality of candidate virtual speakers.

FIG. 4B is a diagram of an example distribution of candidate virtual speakers. In FIG. 4B, the plurality of candidate virtual speakers may be evenly distributed on the spherical surface, and one point on the spherical surface represents one candidate virtual speaker.

It should be noted that a quantity of candidate virtual speakers and a distribution of the candidate virtual speakers are not limited in this disclosure, and may be set according to a requirement. Details are described below.

For example, the target virtual speaker whose location corresponds to the location of the sound source in the scene audio signal may be selected from the plurality of candidate virtual speakers based on the scene audio signal. There may be one or more target virtual speakers. This is not limited in this disclosure. For details, refer to S11 to S13.

S11: Obtain a plurality of groups of virtual speaker coefficients corresponding to the plurality of candidate virtual speakers, where the plurality of groups of virtual speaker coefficients are in one-to-one correspondence with the plurality of candidate virtual speakers.

For example, first configuration information of an encoding module (for example, a scene audio encoding module) may be obtained; second configuration information of the candidate virtual speaker is determined based on the first configuration information of the encoding module; and the plurality of candidate virtual speakers are generated based on the second configuration information of the candidate virtual speaker.

For example, the first configuration information includes but is not limited to an encoding bit rate and user-defined information (for example, an HOA order quantity (which is an order quantity of an HOA signal that may be encoded by the encoding module) corresponding to the encoding module, an order quantity (an expected order quantity of a reconstructed HOA signal obtained by a decoder side through decoding) of a reconstructed scene audio signal, and a format (an expected format of the reconstructed HOA signal obtained by the decoder side through decoding) of the reconstructed scene audio signal). This is not limited in this disclosure.

For example, the second configuration information includes but is not limited to information such as a total quantity of candidate virtual speakers, an HOA order quantity of each candidate virtual speaker, and location information of each candidate virtual speaker. This is not limited in this disclosure.

For example, the second configuration information of the candidate virtual speaker may be determined based on the first configuration information of the encoding module in a plurality of manners. For example, a small quantity of candidate virtual speakers may be configured if the encoding bit rate is low; or a plurality of candidate virtual speakers may be configured if the encoding bit rate is high. For another example, the HOA order quantity of the virtual speaker may be configured as the HOA order quantity of the encoding module. In this embodiment of this disclosure, in addition to determining the second configuration information of the candidate virtual speaker based on the first configuration information of the encoding module, the second configuration information of the candidate virtual speaker may also be determined based on the user-defined information (for example, information such as the total quantity of candidate virtual speakers, the HOA order quantity of each candidate virtual speaker, and the location information of each candidate virtual speaker that may be customized by a user). This is not limited.

For example, a configuration table may be preset. The configuration table includes a relationship between a quantity of candidate virtual speakers and location information of the candidate virtual speakers. In this way, after the total quantity of candidate virtual speakers is determined, the location information of each candidate virtual speaker may be determined by searching the configuration table.

For example, after the second configuration information of the candidate virtual speaker is determined, the plurality of candidate virtual speakers may be generated based on the second configuration information of the candidate virtual speaker. For example, a corresponding quantity of candidate virtual speakers may be generated based on the total quantity of candidate virtual speakers, and the HOA order quantity of each candidate virtual speaker is set based on the HOA order quantity of each candidate virtual speaker; and a location of each candidate virtual speaker is set based on the location information of each candidate virtual speaker.

For example, when each candidate virtual speaker serves as a virtual sound source, a virtual speaker signal generated by the virtual sound source is a plane wave, and the plane wave may be expanded in a spherical coordinate system. For an ideal plane wave whose amplitude is S and direction is (θₛ, φₛ), a form obtained through expansion based on a spherical harmonic function may be shown in Formula (3). The HOA order quantity of the candidate virtual speaker is a truncated value of m in Formula (3).

Then, a virtual speaker coefficient corresponding to each candidate virtual speaker may be determined based on the HOA order quantity of each candidate virtual speaker (each candidate virtual speaker corresponds to one group of virtual speaker coefficients). For example, for a candidate virtual speaker, with reference to Formula (3), the truncated value of m in Formula (3) is set to the HOA order quantity of the candidate virtual speaker, and (θₛ, φₛ) in Formula (3) is set to the location information (θₛ₃, φₛ₃) of the candidate virtual speaker. In this case, B_{m,n}^{σ} in Formula (3) is one group of virtual speaker coefficients (the virtual speaker coefficient is also an HOA coefficient). It should be noted that, it can be learned from Formula (3) that when the location of the candidate virtual speaker is different from the location of the sound source in the scene audio signal, the virtual speaker coefficient of the candidate virtual speaker and the scene audio signal are different HOA coefficients). In this way, one group of virtual speaker coefficients corresponding to each candidate virtual speaker may be determined.

S12: Select the target virtual speaker from the plurality of candidate virtual speakers based on the scene audio signal and the plurality of groups of virtual speaker coefficients.

For example, a dot product of the scene audio signal and each of the plurality of groups of virtual speaker coefficients is obtained, to obtain a plurality of dot product values. The plurality of dot product values are in one-to-one correspondence with the plurality of groups of virtual speaker coefficients. For example, a dot product of one group of virtual speaker coefficients corresponding to each of the plurality of candidate virtual speakers and the scene audio signal may be obtained, to obtain a corresponding dot product value.

Then, the target virtual speaker may be selected from the plurality of candidate virtual speakers based on the plurality of dot product values. In a possible manner, first G (G is a positive integer) candidate virtual speakers with largest dot product values may be selected as target virtual speakers. In a possible manner, a candidate virtual speaker with a largest dot product may be first selected as a target virtual speaker; the scene audio signal is projected and superimposed on a linear combination of a group of virtual speaker coefficients corresponding to the candidate virtual speaker with the largest dot product, to obtain a projection vector; and the projection vector is subtracted from the scene audio signal, to obtain a difference. Then, the foregoing process is repeated for the difference, to implement iterative calculation, and one target virtual speaker is generated each time of iteration.

S13: Obtain the attribute information of the target virtual speaker.

In a possible manner, the attribute information of the target virtual speaker is generated based on location information of the target virtual speaker. In a possible manner, the location information (including pitch angle information and horizontal angle information) of the target virtual speaker may be used as the attribute information of the target virtual speaker. In a possible manner, a location index (including a pitch angle index (which may be used to uniquely identify the pitch angle information) and a horizontal angle index (which may be used to uniquely identify the horizontal angle information)) corresponding to the location information of the target virtual speaker are used as the attribute information of the target virtual speaker.

In a possible manner, a virtual speaker index (for example, a virtual speaker identifier) of the target virtual speaker may be used as the attribute information of the target virtual speaker. The virtual speaker index is in one-to-one correspondence with the location information.

In a possible manner, the virtual speaker coefficient of the target virtual speaker may be used as the attribute information of the target virtual speaker. For example, C virtual speaker coefficients of the target virtual speaker may be determined, and the C virtual speaker coefficients of the target virtual speaker are used as the attribute information of the target virtual speaker. The C virtual speaker coefficients of the target virtual speaker are in one-to-one correspondence with an audio signal with C channels included in the reconstructed scene audio signal.

It should be noted that, a data amount of the virtual speaker coefficient is far greater than a data amount of the location information, a data amount of an index of the location information, and a data amount of the virtual speaker index. Specific information that is in the location information, the index of the location information, the virtual speaker index, and the virtual speaker coefficient and that is used as the attribute information of the target virtual speaker may be determined based on a bandwidth. For example, when the bandwidth is large, the virtual speaker coefficient may be used as the attribute information of the target virtual speaker. In this way, the decoder side does not need to calculate the virtual speaker coefficient of the target virtual speaker, and computational power of the decoder side may be saved. When the bandwidth is small, any one of the location information, the index of the location information, and the virtual speaker index may be used as the attribute information of the target virtual speaker. In this way, a bit rate may be reduced. It should be understood that, specific information that is in the location information, the index of the location information, the virtual speaker index, and the virtual speaker coefficient and that is used as the attribute information of the target virtual speaker may alternatively be preset. This is not limited in this disclosure.

In a possible manner, the target virtual speaker may be preset.

It should be understood that a manner of determining the target virtual speaker is not limited in this disclosure, and a manner of determining the attribute information of the target virtual speaker is not limited in this disclosure.

For example, for a channel, when an encoding scheme corresponding to the channel is a third encoding scheme (a de-correlation encoding scheme), an audio signal with the channel may not be processed; but instead, the decoder side performs a de-correlation decoding scheme for the channel, to determine a reconstructed audio signal with the channel.

In a possible manner, the de-correlation encoding scheme may include a time-domain de-correlation encoding scheme and a frequency-domain de-correlation encoding scheme. When the third encoding scheme is the de-correlation encoding scheme, encoding the channel based on the third encoding scheme may be: determining, for the channel, whether the third encoding scheme is the time-domain de-correlation encoding scheme or the frequency-domain de-correlation encoding scheme. When the third encoding scheme is the time-domain de-correlation encoding scheme, the audio signal with the channel may not be processed, and only a second preset identifier corresponding to the channel is encoded. The second preset identifier indicates that the third encoding scheme of the channel is the time-domain de-correlation encoding scheme. When the third encoding scheme is the frequency-domain de-correlation encoding scheme, the audio signal with the channel may not be processed, and only a third preset identifier corresponding to the channel is encoded. The third preset identifier indicates that the third encoding scheme of the channel is a frequency-domain de-correlation encoding scheme. In this way, the decoder side learns of whether the third encoding scheme is the time-domain de-correlation encoding scheme or the frequency-domain de-correlation encoding scheme, and then perform decoding based on a corresponding de-correlation decoding scheme algorithm.

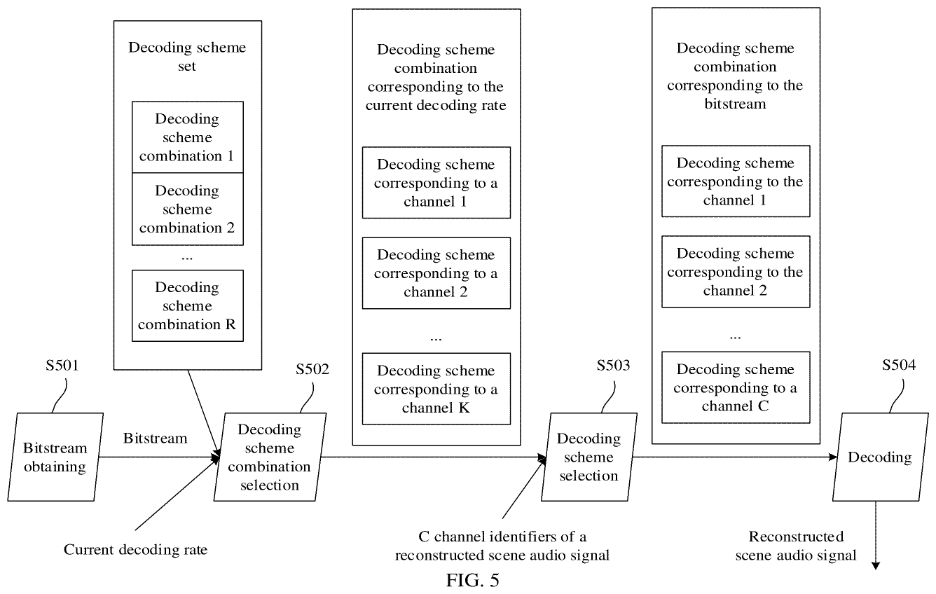

FIG. 5 is a diagram of an example scene audio decoding process. The embodiment in FIG. 5 is a decoding process corresponding to the encoding process in the embodiment in FIG. 4A.

S501: Receive a bitstream.

In a possible manner, a decoding scheme set may be searched for a decoding scheme combination corresponding to the bitstream based on a current decoding rate. For details, refer to S502 and S503.

S502: Search the decoding scheme set for a decoding scheme combination corresponding to the current decoding rate, where the decoding scheme combination corresponding to the current decoding rate includes decoding schemes corresponding to K channels, and K is greater than or equal to C.

For example, the decoding scheme set in Table 2 may be first searched for the decoding scheme combination corresponding to the current decoding rate based on the current decoding rate.

For example, if the current decoding rate is 256 kbps, it is found, from the decoding scheme set in Table 2, that the decoding scheme combination corresponding to the current decoding rate is the decoding scheme combination 1.

For example, if the current decoding rate is 384 kbps, it is found, from the decoding scheme set in Table 2, that the decoding scheme combination corresponding to the current decoding rate is the decoding scheme combination 2.

For example, if the current decoding rate is 512 kbps, it is found, from the decoding scheme set in Table 2, that the decoding scheme combination corresponding to the current decoding rate is the decoding scheme combination 3.

For example, if the current decoding rate is 768 kbps, it is found, from the decoding scheme set in Table 2, that the decoding scheme combination corresponding to the current decoding rate is the decoding scheme combination 4 or the decoding scheme combination 5.

For example, the decoding scheme combination corresponding to the current decoding rate may include the decoding schemes corresponding to the K channels. K is greater than or equal to C.

S503: Select decoding schemes corresponding to C channels in a reconstructed scene audio signal from the decoding scheme combination corresponding to the current decoding rate, to form the decoding scheme combination corresponding to the bitstream.

For example, when K is greater than C, the decoding schemes corresponding to the C channels in the reconstructed scene audio signal may be selected from the decoding scheme combination corresponding to the current decoding rate, to form the decoding scheme combination corresponding to the bitstream. For example, C target channels that are in K channels in Table 2 and that correspond to the C channels in the reconstructed scene audio signal may be determined; and then decoding schemes corresponding to the C target channels are selected from Table 2, to form the decoding scheme combination corresponding to the bitstream.

For example, when an identification manner (for example, a channel number allocation manner) of the K channels in Table 2 is the same as an identification manner of the C channels in the reconstructed scene audio signal, decoding schemes corresponding to first C channels may be selected from the decoding scheme combination corresponding to the current decoding rate, to form the decoding scheme combination corresponding to the bitstream.

For example, if K=16 and C=9, decoding schemes corresponding to first nine channels may be selected from the decoding scheme combination corresponding to the current decoding rate, to form the decoding scheme combination corresponding to the bitstream.

For example, if K=16 and C=4, decoding schemes corresponding to first four channels may be selected from the decoding scheme combination corresponding to the current decoding rate, to form the decoding scheme combination corresponding to the bitstream.

For example, if K=16 and C=1, a decoding scheme corresponding to a first channel may be selected from the decoding scheme combination corresponding to the current decoding rate, to form the decoding scheme combination corresponding to the bitstream.

For example, when K=C in Table 2, the decoding scheme combination corresponding to the current decoding rate is the decoding scheme combination corresponding to the bitstream.

S504: Decode the C channels based on the bitstream and the decoding schemes corresponding to the C channels, to obtain the reconstructed scene audio signal, where C is a positive integer.

For example, for a channel, when a decoding scheme corresponding to the channel is a first decoding scheme (a direct decoding scheme), the bitstream is parsed, to determine encoded data corresponding to an audio signal with the channel; and then operations such as entropy decoding, dequantization, bit allocation, post-processing, and time-frequency transform are performed on the encoded data corresponding to the audio signal with the channel, to obtain a reconstructed audio signal with the channel.

For example, for a channel, a process of decoding the channel based on the second decoding scheme (a spatial decoding scheme) may include S21 to S24. C1 is equal to (M+1)²

S21: Determine a first virtual speaker coefficient corresponding to a target virtual speaker based on attribute information of the target virtual speaker.

For example, an encoder side may write M into a first bitstream, and further, M may be obtained from the first bitstream through decoding (the encoder side and a decoder side may also pre-agree on M, and this is not limited in this disclosure). For example, when the attribute information of the target virtual speaker is location information, the location information of the target virtual speaker may be substituted into Formula (3), and m in Formula (3) is equal to M, so that the first virtual speaker coefficient corresponding to the target virtual speaker may be obtained. The first virtual speaker coefficient includes (M+1)² virtual speaker coefficients, and the (M+1)² virtual speaker coefficients correspond to C1 channels.

For example, when the attribute information of the target virtual speaker is a location index of the location information, the location information of the target virtual speaker may be determined based on a relationship between location information and a location index; and then the first virtual speaker coefficient is determined in the foregoing manner. This is not described herein again.

For example, when the attribute information of the target virtual speaker is a virtual speaker index, the location information of the target virtual speaker may be determined based on a relationship between location information and a virtual speaker index; and then the first virtual speaker coefficient is determined in the foregoing manner. This is not described herein again.

For example, when the attribute information of the target virtual speaker is a virtual speaker coefficient, it can be learned from the foregoing descriptions that a group of virtual speaker coefficients corresponding to the target virtual speaker include C virtual speaker coefficients. In this case, (M+1)² virtual speaker coefficients corresponding to (M+1)² channels included in the reconstructed audio signal with C1 channels may be selected as the first virtual speaker coefficient.

S22: Generate a virtual speaker signal based on the reconstructed audio signal with the C1 channels and the first virtual speaker coefficient.

For example, the virtual speaker signal may be generated based on the reconstructed audio signal with the C1 channels and the first virtual speaker coefficient.

For example, it is assumed that a matrix A whose size is (Y1×P) represents the first virtual speaker coefficient of the target virtual speaker. Herein, Y1 (Y1 is a positive integer) is a quantity of target virtual speakers, and P is a channel quantity (M+1)² of an audio signal included in the reconstructed audio signal with the C1 channels. In addition, a matrix X whose size is (L×P) represents the reconstructed audio signal with the C1 channels. L is a quantity of sampling points of the reconstructed audio signal with the C1 channels. A theoretical optimal solution W is obtained in a least square method, and W represents the virtual speaker signal, as shown in Formula (5).

w=A⁻¹X (5)

A matrix A⁻¹ is an inverse matrix of the matrix A.

S23: Determine a second virtual speaker coefficient corresponding to the target virtual speaker based on the attribute information of the target virtual speaker.

For example, it may be determined, based on an expected order quantity N of the reconstructed scene audio signal, that m in formula (3) is equal to N. Then, when the attribute information of the target virtual speaker is the location information, the location information of the target virtual speaker may be substituted into Formula (3), and m in Formula (3) is equal to N, so that the second virtual speaker coefficient may be obtained. The second virtual speaker coefficient includes C virtual speaker coefficients, and the C virtual speaker coefficients correspond to the C channels in the reconstructed scene audio signal.

For example, when the attribute information of the target virtual speaker is a location index of the location information, the location information of the target virtual speaker may be determined based on a relationship between location information and a location index; and then the first virtual speaker coefficient is determined in the foregoing manner. This is not described herein again.

For example, when the attribute information of the target virtual speaker is a virtual speaker index, the location information of the target virtual speaker may be determined based on a relationship between location information and a virtual speaker index; and then the first virtual speaker coefficient is determined in the foregoing manner. This is not described herein again.

For example, when the attribute information of the target virtual speaker is the virtual speaker coefficient, the attribute information of the target virtual speaker may be directly used as the second virtual speaker coefficient.

S24: Obtain the reconstructed audio signal with the channel based on the virtual speaker signal and the second virtual speaker coefficient.

For example, it is assumed that the matrix A whose size is (Y1×C) represents the second virtual speaker coefficient. Y1 is the quantity of target virtual speakers, and C is the channel quantity of the reconstructed scene audio signal. In addition, the matrix B whose size is (L×Y1) represents the virtual speaker signal. L is a quantity of sampling points of the reconstructed scene audio signal. In this case, the reconstructed scene audio signal may be represented by H, as shown in Formula (6).

H=BA (6)

Then, the reconstructed audio signal with the channel may be selected from the reconstructed scene audio signal.

In a possible manner, in an encoding process, feature information corresponding to the channel in the scene audio signal may be further extracted, and encoded and sent to the decoder side. After receiving the bitstream, the decoder side may compensate the reconstructed audio signal with the channel based on the feature information, so that audio quality of the reconstructed audio signal with the channel in the reconstructed scene audio signal can be improved.

For example, gain information Gain(i) corresponding to the channel in the scene audio signal may be calculated with reference to Formula (7).

$$Gain ( i ) = E ( i ) / E ( 1 ) \qquad ( 7 )$$

Herein, i is a channel number of the channel, E(i) is energy of an i^{th} channel, and E(1) is energy of an audio signal with C channels in the scene audio signal.

For example, when the feature information is gain information, compensation may be performed with reference to Formula (8).

$$E ( i ) = Gain ( i ) * E ( 1 ) \qquad ( 8 )$$

Herein, i is a channel number of C channels, E(i) is energy of an i^{th} channel, E(1) is energy of a reconstructed audio signal with C channels in the reconstructed scene audio signal, and Gain(i) is gain information corresponding to the channel in the reconstructed scene audio signal.

In a possible manner, for a channel, a process of decoding the channel based on the bitstream and the third decoding scheme (a de-correlation decoding scheme) may be: processing, by using an all-pass filter, a reconstructed audio signal with one or more channels (for example, a channel 1) that is obtained through decoding based on the first decoding scheme, to obtain the reconstructed audio signal with the channel.

In this way, an encoding and decoding scheme combination used for encoding and decoding is selected from an encoding and decoding scheme set based on a current encoding rate (the current decoding rate) and a channel identifier of the scene audio signal, so that encoding and decoding can adapt to a current encoding and decoding rate, thereby ensuring audio smoothness. In addition, this is also applicable to encoding and decoding of scene audio signals including different channel quantities, and is highly universal. In addition, because an encoding and decoding scheme combination with good coding performance may be selected for establishment of an encoding and decoding scheme set, this disclosure can also ensure, to some extent, encoding quality of various scene audio signals including different channel quantities.

The following describes scene audio signal encoding and decoding processes by using the encoding scheme sets in Table 3 and Table 4 and the decoding scheme sets in Table 5 and Table 6 as examples. An example in which a to-be-encoded scene audio signal is an N1-order HOA signal is used for description.

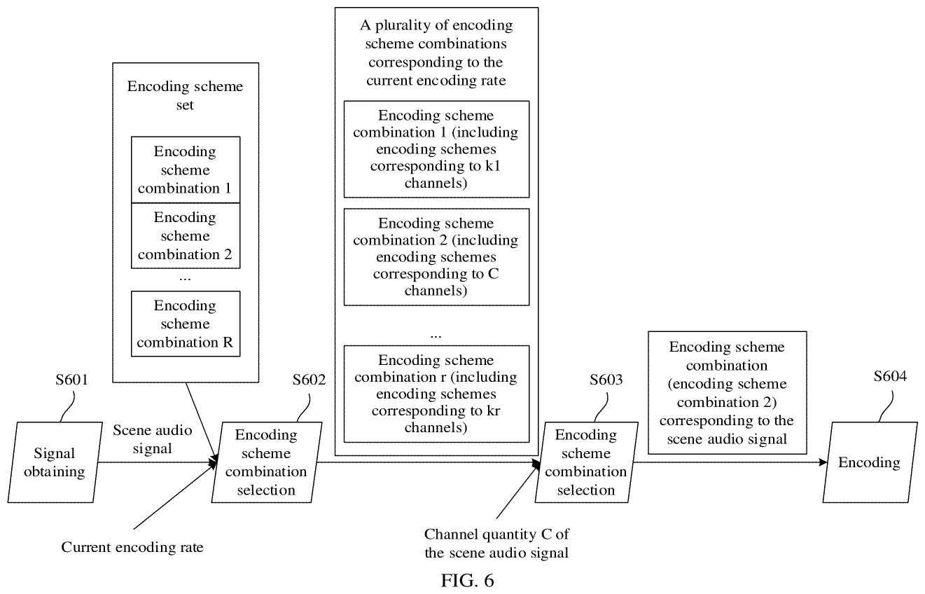

FIG. 6 is a diagram of an example scene audio signal encoding process.

S601: Obtain a scene audio signal.

For example, the scene audio signal is an N1-order HOA signal, the N1-order HOA signal includes an audio signal with C channels, and C is equal to the square of (N1+1).

In a possible manner, an encoding scheme set may be searched for an encoding scheme combination corresponding to the scene audio signal based on a current encoding rate. For details, refer to S602 and S603.

S602: Search the encoding scheme set for a plurality of encoding scheme combinations corresponding to the current encoding rate, where the plurality of encoding scheme combinations corresponding to the current encoding rate correspond to a plurality of channel quantities.

For example, the encoding scheme sets in Table 3 and Table 4 may be first searched for the plurality of encoding scheme combinations corresponding to the current encoding rate based on the current encoding rate.

For example, if the current encoding rate is 256 kbps, it is found, from the encoding scheme set in Table 3, that the plurality of encoding scheme combinations corresponding to the current encoding rate include the encoding scheme combination 1, the encoding scheme combination 2, and the encoding scheme combination 3.

For example, if the current encoding rate is 384 kbps, it is found, from the encoding scheme set in Table 4, that the plurality of encoding scheme combinations corresponding to the current encoding rate include the encoding scheme combination 4, the encoding scheme combination 5, and the encoding scheme combination 6.

For example, there may be r (r is a positive integer, and r is less than or equal to R) encoding scheme combinations corresponding to the current encoding rate. Each encoding scheme combination may include encoding schemes corresponding to a plurality of channels. For example, the encoding combination manner 1 includes encoding schemes corresponding to k1 (k1 is a positive integer) channels, the encoding combination manner 2 includes encoding schemes corresponding to the C channels, and an encoding combination manner r includes encoding schemes corresponding to kr (kr is a positive integer) channels.

S603: Search the plurality of encoding scheme combinations corresponding to the current encoding rate for the encoding scheme combination corresponding to the scene audio signal based on a channel quantity C of the scene audio signal.

For example, if the current encoding rate is 256 kbps and C=16, the encoding scheme combination 1 may be selected from the encoding scheme combination 1, the encoding scheme combination 2, and the encoding scheme combination 3 as the encoding scheme combination corresponding to the scene audio signal.

For example, if the current encoding rate is 256 kbps and C=9, the encoding scheme combination 2 may be selected from the encoding scheme combination 1, the encoding scheme combination 2, and the encoding scheme combination 3 as the encoding scheme combination corresponding to the scene audio signal.

For example, if the current encoding rate is 256 kbps and C=4, the encoding scheme combination 3 may be selected from the encoding scheme combination 1, the encoding scheme combination 2, and the encoding scheme combination 3 as the encoding scheme combination corresponding to the scene audio signal.

For example, if the current encoding rate is 384 kbps and C=16, the encoding scheme combination 4 may be selected from the encoding scheme combination 4, the encoding scheme combination 5, and the encoding scheme combination 6 as the encoding scheme combination corresponding to the scene audio signal.

For example, if the current encoding rate is 384 kbps and C=9, the encoding scheme combination 5 may be selected from the encoding scheme combination 4, the encoding scheme combination 5, and the encoding scheme combination 6 as the encoding scheme combination corresponding to the scene audio signal.

For example, if the current encoding rate is 384 kbps and C=4, the encoding scheme combination 6 may be selected from the encoding scheme combination 4, the encoding scheme combination 5, and the encoding scheme combination 6 as the encoding scheme combination corresponding to the scene audio signal.

S604: Encode the C channels in the scene audio signal based on the encoding schemes corresponding to the C channels, where C is a positive integer.

For details, refer to the descriptions of S404. Details are not described herein again.

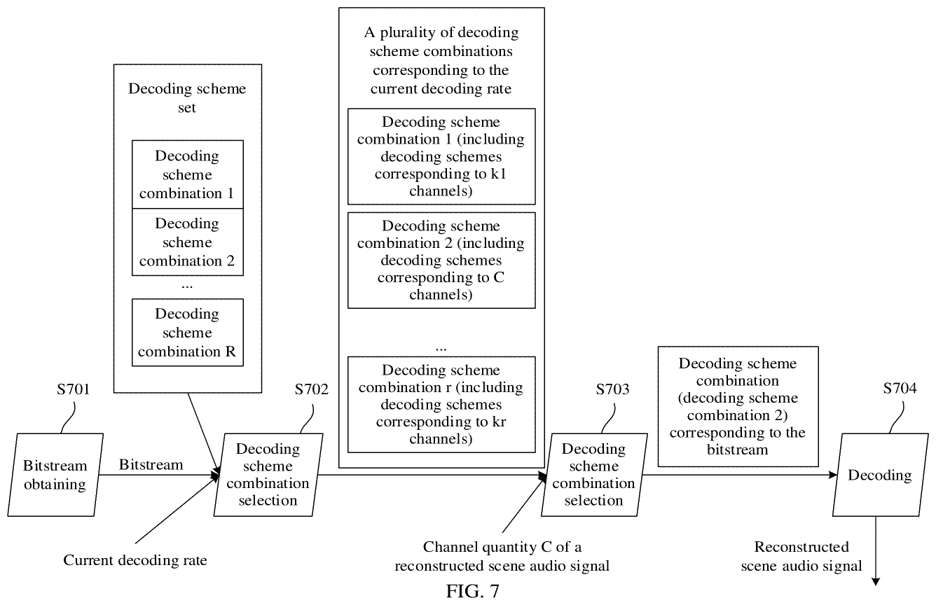

FIG. 7 is a diagram of an example scene audio decoding process. The embodiment in FIG. 7 is a decoding process corresponding to the encoding process in the embodiment in FIG. 6.

S701: Receive a bitstream.

In a possible manner, a decoding scheme set may be searched for a decoding scheme combination corresponding to the bitstream based on a current decoding rate. For details, refer to S702 and S703.

S702: Search the decoding scheme set for a plurality of decoding scheme combinations corresponding to the current decoding rate, where the plurality of decoding scheme combinations corresponding to the current decoding rate correspond to a plurality of channel quantities.

For example, the decoding scheme sets in Table 5 and Table 6 may be first searched for the plurality of decoding scheme combinations corresponding to the current decoding rate based on the current decoding rate.

For example, if the current decoding rate is 256 kbps, it is found, from the decoding scheme set in Table 5, that one decoding scheme combination corresponding to the current decoding rate includes the decoding scheme combination 1, the decoding scheme combination 2,and the decoding scheme combination 3.

For example, if the current decoding rate is 384 kbps, it is found, from the decoding scheme set in Table 6, that one decoding scheme combination corresponding to the current decoding rate includes the decoding scheme combination 4, the decoding scheme combination 5,and the decoding scheme combination 6.

For example, there may be r (r is a positive integer, and r is less than or equal to R) decoding scheme combinations corresponding to the current decoding rate. Each decoding scheme combination may include decoding schemes corresponding to a plurality of channels. For example, the decoding combination manner 1 includes decoding schemes corresponding to k1 (k1 is a positive integer) channels, the decoding combination manner 2 includes decoding schemes corresponding to C channels, and a decoding combination manner r includes decoding schemes corresponding to kr (kr is a positive integer) channels.

S703: Search the plurality of decoding scheme combinations corresponding to the current decoding rate for the decoding scheme combination corresponding to the bitstream based on a channel quantity C of the reconstructed scene audio signal.

For example, if the current decoding rate is 256 kbps and C=16, the decoding scheme combination 1 may be selected from the decoding scheme combination 1, the decoding scheme combination 2, and the decoding scheme combination 3 as the decoding scheme combination corresponding to the bitstream.

For example, if the current decoding rate is 256 kbps and C=9, the decoding scheme combination 2 may be selected from the decoding scheme combination 1, the decoding scheme combination 2, and the decoding scheme combination 3 as the decoding scheme combination corresponding to the bitstream.

For example, if the current decoding rate is 256 kbps and C=4, the decoding scheme combination 3 may be selected from the decoding scheme combination 1, the decoding scheme combination 2, and the decoding scheme combination 3 as the decoding scheme combination corresponding to the bitstream.

For example, if the current decoding rate is 384 kbps and C=16, the decoding scheme combination 4 may be selected from the decoding scheme combination 4, the decoding scheme combination 5, and the decoding scheme combination 6 as the decoding scheme combination corresponding to the bitstream.

For example, if the current decoding rate is 384 kbps and C=9, the decoding scheme combination 5 may be selected from the decoding scheme combination 4, the decoding scheme combination 5, and the decoding scheme combination 6 as the decoding scheme combination corresponding to the bitstream.

For example, if the current decoding rate is 384 kbps and C=4, the decoding scheme combination 6 may be selected from the decoding scheme combination 4, the decoding scheme combination 5, and the decoding scheme combination 6 as the decoding scheme combination corresponding to the bitstream.

S704: Decode the C channels based on the bitstream and the decoding schemes corresponding to the C channels, to obtain the reconstructed scene audio signal, where C is a positive integer.

For details, refer to the descriptions of S504. Details are not described herein again.

In this way, an encoding and decoding scheme combination used for encoding and decoding is selected from an encoding and decoding scheme set based on a current encoding rate (the current decoding rate) and a channel quantity of the scene audio signal, so that encoding and decoding can adapt to a current coding rate, thereby ensuring audio smoothness. In addition, this is also applicable to encoding of scene audio signals including different channel quantities, and is highly universal. In addition, because an encoding and decoding scheme combination with good coding performance may be selected for establishment of an encoding and decoding scheme set, this disclosure can also ensure, to some extent, encoding quality of various scene audio signals including different channel quantities.

The following describes scene audio signal encoding and decoding processes by using the encoding scheme set in Table 7 and the decoding scheme set in Table 8 as examples. An example in which a to-be-encoded scene audio signal is an N1-order HOA signal is used for description.

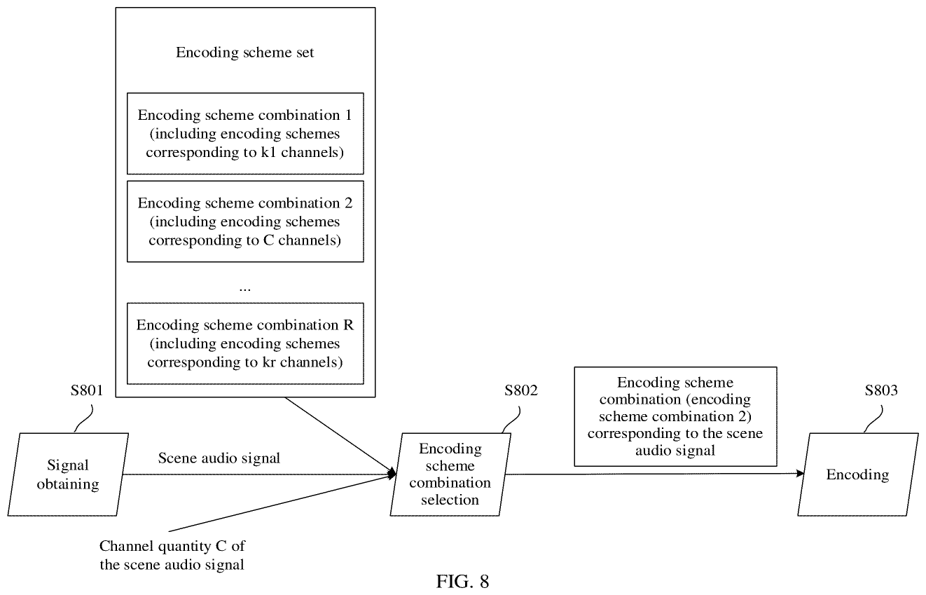

FIG. 8 is a diagram of an example scene audio signal encoding process.

S801: Obtain a scene audio signal.

For example, the scene audio signal is an N1-order HOA signal, the NI-order HOA signal includes an audio signal with C channels, and C is equal to the square of (N1+1).

S602: Search an encoding scheme set for an encoding scheme combination corresponding to the scene audio signal based on a channel quantity C of the scene audio signal.

For example, if C=16, it is found, from the encoding scheme set in Table 7, that an encoding scheme combination corresponding to the channel quantity C of the scene audio signal is the encoding scheme combination 1, and the encoding scheme combination 1 is used as the encoding scheme combination corresponding to the scene audio signal.

For example, if C=9, it is found, from the encoding scheme set in Table 7, that an encoding scheme combination corresponding to the channel quantity C of the scene audio signal is the encoding scheme combination 2, and the encoding scheme combination 2 is used as the encoding scheme combination corresponding to the scene audio signal.

For example, if C=4, it is found, from the encoding scheme set in Table 7, that an encoding scheme combination corresponding to the channel quantity C of the scene audio signal is the encoding scheme combination 3, and the encoding scheme combination 3 is used as the encoding scheme combination corresponding to the scene audio signal.

S803: Encode the C channels in the scene audio signal based on encoding schemes corresponding to the C channels, where C is a positive integer.

For details, refer to the descriptions of S404. Details are not described herein again.

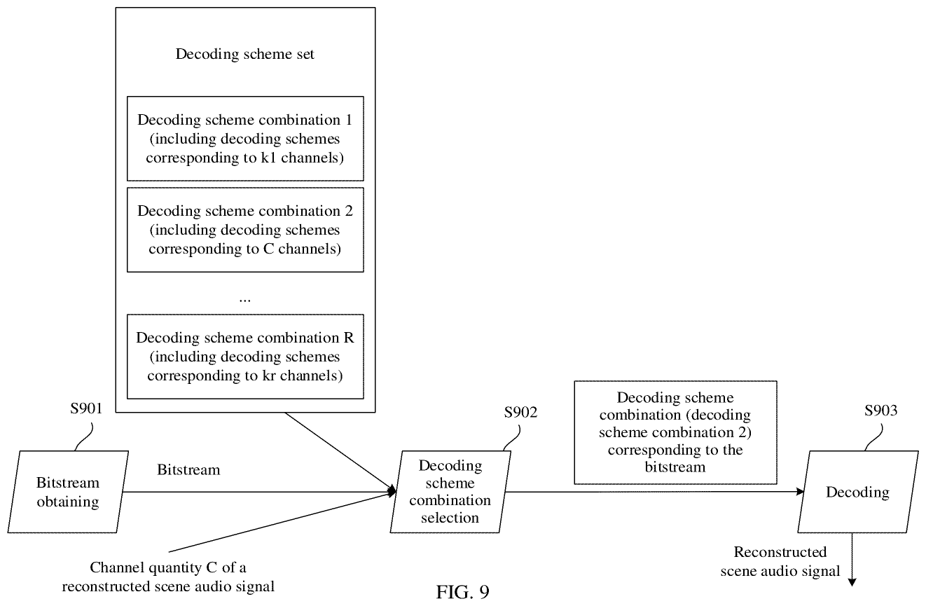

FIG. 9 is a diagram of an example scene audio decoding process. The embodiment in FIG. 9 is a decoding process corresponding to the encoding process in the embodiment in FIG. 8.

S901: Receive a bitstream.

S902: Search a decoding scheme set for a decoding scheme combination corresponding to the bitstream based on a channel quantity C of a reconstructed scene audio signal.

For example, if C=16, it is found, from the decoding scheme set in Table 8, that a decoding scheme combination corresponding to the channel quantity C of the scene audio signal is the decoding scheme combination 1, and the decoding scheme combination 1 is used as the decoding scheme combination corresponding to the bitstream.

For example, if C=9, it is found, from the decoding scheme set in Table 8, that a decoding scheme combination corresponding to the channel quantity C of the scene audio signal is the decoding scheme combination 2, and the decoding scheme combination 2 is used as the decoding scheme combination corresponding to the bitstream.

For example, if C=4, it is found, from the decoding scheme set in Table 8, that a decoding scheme combination corresponding to the channel quantity C of the scene audio signal is the decoding scheme combination 3, and the decoding scheme combination 3 is used as the decoding scheme combination corresponding to the bitstream.

S903: Decode C channels based on the bitstream and decoding schemes corresponding to the C channels, to obtain the reconstructed scene audio signal, where C is a positive integer.

For details, refer to the descriptions of S504. Details are not described herein again.

In this way, selecting an encoding and decoding scheme combination used for encoding and decoding from an encoding and decoding scheme set based on the channel quantity of the scene audio signal is applicable to encoding and decoding of scene audio signals including different channel quantities, and is highly universal. In addition, because an encoding and decoding scheme combination with good coding performance may be selected for establishment of the encoding and decoding scheme set, this disclosure can also ensure, to some extent, encoding quality of various scene audio signals including different channel quantities.

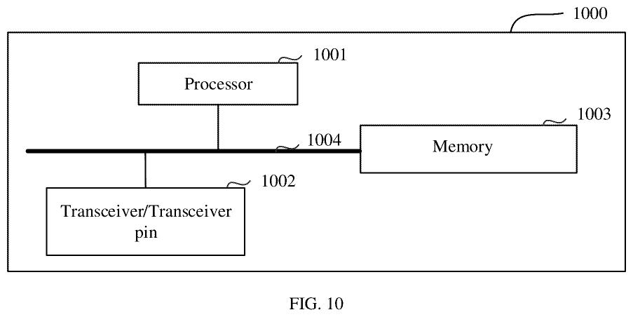

In an example, FIG. 10 is a block diagram of an apparatus 1000 according to an embodiment of this disclosure. The apparatus 1000 may include a processor 1001 and a transceiver/transceiver pin 1002, and optionally further includes a memory 1003.

Components of the apparatus 1000 are coupled together through a bus 1004. In addition to a data bus, the bus 1004 further includes a power bus, a control bus, and a status signal bus. However, for clarity of description, various buses are referred to as the bus 1004 in the figure.

Optionally, the memory 1003 may be configured to store instructions in the foregoing method embodiments. The processor 1001 may be configured to execute the instructions in the memory 1003, control a receive pin to receive a signal, and control a transmit pin to send a signal.

The apparatus 1000 may be the electronic device in the foregoing method embodiments or a chip of the electronic device.

The electronic device may be a terminal device or a server.

All related content of the steps in the foregoing method embodiments may be cited in function descriptions of the corresponding functional modules. Details are not described herein again.

An embodiment of this disclosure further provides a chip, including one or more interface circuits and one or more processors. The one or more processors receive or send data through the one or more interface circuits. When the one or more processors execute computer instructions, the electronic device is enabled to perform the foregoing related method steps to implement the method in the foregoing embodiments. The interface circuit is a transceiver/transmit/receive pin 1002.

An embodiment further provides a computer-readable storage medium. The computer-readable storage medium stores computer instructions. When the computer instructions are run on an electronic device, the electronic device is enabled to perform the foregoing related method steps, to implement the methods in the foregoing embodiments.

An embodiment further provides a computer program product. The computer program product includes computer instructions, and when the computer instructions are executed by a computer or a processor, the computer is enabled to perform the foregoing related steps to implement the method in the foregoing embodiments.

In addition, an embodiment of this disclosure further provides an apparatus. The apparatus may be a chip, a component, or a module. The apparatus may include a processor and a memory that are connected. The memory is configured to store computer-executable instructions. When the apparatus runs, the processor may execute the computer-executable instructions stored in the memory, to enable the chip to perform the method in the foregoing method embodiments.

The electronic device, the computer-readable storage medium, the computer program product, or the chip provided in embodiments is configured to perform the corresponding method provided above. Therefore, for beneficial effect that can be achieved, refer to beneficial effect in the corresponding method provided above. Details are not described herein.

Based on the descriptions about the foregoing implementations, a person skilled in the art may understand that, for a purpose of convenient and brief description, division into the foregoing functional modules is used as an example for illustration. In some instances, the foregoing functions may be allocated to different functional modules and implemented according to requirements. In other words, an inner structure of an apparatus is divided into different functional modules to implement all or some of the functions described above.

In the several embodiments provided in this disclosure, it should be understood that the disclosed apparatus and method may be implemented in another manner. For example, the described apparatus embodiment is an example. For example, division into modules or units is logical functional division and may be other division in some implementations. For example, a plurality of units or components may be combined or integrated into another apparatus, or some features may be ignored or not performed. In addition, the displayed or discussed mutual couplings or direct couplings or communication connections may be implemented through some interfaces. The indirect couplings or communication connections between the apparatuses or units may be implemented in electrical, mechanical, or another form.

The units described as separate parts may or may not be physically separate, and parts displayed as units may be one or more physical units, may be located in one place, or may be distributed on different places. Some or all of the units may be selected according to a requirement, to achieve the objectives of the solutions of embodiments.

In addition, functional units in embodiments of this disclosure may be integrated into one processing unit, each of the units may exist alone physically, or two or more units may be integrated into one unit. The integrated unit may be implemented in a form of hardware, or may be implemented in a form of a software functional unit.

Any content in embodiments of this disclosure and any content in a same embodiment can be freely combined. Any combination of the foregoing content falls within the scope of this disclosure.

When the integrated unit is implemented in the form of a software functional unit and sold or used as an independent product, the integrated unit may be stored in a readable storage medium. Based on such an understanding, the technical solutions of embodiments of this disclosure essentially, or the part contributing to an example technology, or all or some of the technical solutions may be implemented in a form of a software product. The software product is stored in a storage medium and includes several instructions for instructing a device (which may be a single-chip microcomputer, a chip, or the like) or a processor to perform all or some of the steps of the methods described in embodiments of this disclosure. The storage medium includes various media that can store program code, for example, a universal serial bus (USB) flash drive, a removable hard disk drive, a read-only memory (ROM), a random-access memory (RAM), a magnetic disk, or an optical disc.

The foregoing describes embodiments of this disclosure with reference to the accompanying drawings. However, this disclosure is not limited to the foregoing specific implementations. The foregoing specific implementations are examples instead of limitations. Inspired by this disclosure, a person of ordinary skill in the art may further make modifications without departing from the purposes of this disclosure and the protection scope of the claims, and all the modifications shall fall within the protection of this disclosure.

Methods or algorithm steps described in combination with the content disclosed in this embodiment of this disclosure may be implemented by hardware, or may be implemented by a processor by executing a software instruction. The software instruction may include a corresponding software module. The software module may be stored in a RAM, a flash memory, a ROM, an erasable programmable ROM (EPROM), an electrically EPROM (EEPROM), a register, a hard disk, a removable hard disk, a compact disc ROM (CD-ROM), or any other form of storage medium well-known in the art. For example, a storage medium is coupled to a processor, so that the processor can read information from the storage medium and write information into the storage medium. The storage medium may be a component of the processor. The processor and the storage medium may be disposed in an application-specific integrated circuit (ASIC).

A person skilled in the art should be aware that in the foregoing one or more examples, functions described in embodiments of this disclosure may be implemented by hardware, software, firmware, or any combination thereof. When the functions are implemented by software, the foregoing functions may be stored in a computer-readable medium or transmitted as one or more instructions or code in a computer-readable medium. The computer-readable medium includes a computer-readable storage medium and a communication medium, where the communication medium includes any medium that enables a computer program to be transmitted from one place to another. The storage medium may be any available medium accessible to a general-purpose or a dedicated computer.

The foregoing describes embodiments of this disclosure with reference to the accompanying drawings. However, this disclosure is not limited to the foregoing specific implementations. The foregoing specific implementations are examples instead of limitations. Inspired by this disclosure, a person of ordinary skill in the art may further make modifications without departing from the purposes of this disclosure and the protection scope of the claims, and all the modifications shall fall within the protection of this disclosure.

What is claimed is:

1. A method comprising:
obtaining a scene audio signal; and
encoding the scene audio signal based on a first encoding scheme combination that corresponds to the scene audio signal and that is from an encoding scheme set, wherein the encoding scheme set comprises encoding scheme combinations respectively corresponding to different types of scene information.

2. The method of claim 1, wherein the scene information comprises an encoding rate, channel information, or the encoding rate and the channel information.

3. The method of claim 1, wherein the first encoding scheme combination comprises a first encoding scheme, a second encoding scheme, or a third encoding scheme, wherein the first encoding scheme is configured to encode a signal, wherein the second encoding scheme is a spatial encoding scheme, wherein the third encoding scheme is different from the first encoding scheme and the second encoding scheme, and wherein the third encoding scheme comprises channel copy encoding.

4. The method of claim 3, wherein the first encoding scheme combination comprises first encoding schemes corresponding to at least two channels and second encoding schemes corresponding to K channels, and wherein the first encoding scheme and the second encoding schemes are different, wherein K is a first positive integer.

5. The method of claim 4, wherein the scene audio signal comprises an audio signal with C channels, wherein the first encoding scheme combination comprises third encoding schemes corresponding to the C channels, wherein encoding the scene audio signal comprises encoding the C channels based on the third encoding schemes, wherein C is a second positive integer, and wherein K is greater than or equal to C.

6. The method of claim 1, further comprising searching the encoding scheme set for the first encoding scheme combination based on current scene information.

7. The method of claim 6, wherein, when a second encoding scheme combination in the encoding scheme set corresponds to one encoding rate, searching the encoding scheme set for the first encoding scheme combination comprises searching the encoding scheme set for the first encoding scheme combination based on a current encoding rate.

8. The method of claim 7, wherein the scene audio signal comprises an audio signal with C channels, and wherein searching the encoding scheme set for the first encoding scheme combination comprises:
searching the encoding scheme set for a plurality of first encoding scheme combinations corresponding to the current encoding rate and a plurality of channel quantities; and
searching the plurality of first encoding scheme combinations for the first encoding scheme combination based on C.

9. The method of claim 7, wherein the scene audio signal comprises an audio signal with C channels, and wherein searching the encoding scheme set for the first encoding scheme combination comprises:
searching the encoding scheme set for a third encoding scheme combination in the encoding scheme set and corresponding to the current encoding rate, wherein the third encoding scheme combination comprises first encoding schemes corresponding to K channels, and wherein K is an integer greater than or equal to C; and
selecting second encoding schemes corresponding to the C channels from the third encoding scheme combination to form the first encoding scheme combination.

10. The method of claim 6, wherein the scene audio signal comprises an audio signal with C channels, and wherein, when a second encoding scheme combination in the encoding scheme set corresponds to one channel quantity, searching the encoding scheme set for the first encoding scheme combination comprises searching the encoding scheme set for the first encoding scheme combination based on C.

11. The method of claim 3, wherein the spatial encoding scheme is a fourth encoding scheme configured to encode attribute information of a target virtual speaker, and wherein the attribute information is based on the scene audio signal.

12. The method of claim 1, further comprising encoding a preset identifier, wherein the preset identifier indicates a scene information type.

13. An electronic device, comprising:
a memory configured to store program instructions; and
one or more processors coupled to the memory and configured to execute the program instructions to cause the electronic device to:
obtain a scene audio signal; and
encode the scene audio signal based on a first encoding scheme combination that corresponds to the scene audio signal and that is from an encoding scheme set, wherein the encoding scheme set comprises encoding scheme combinations corresponding to different types of scene information.

14. The electronic device of claim 13, wherein the first encoding scheme combination comprises a first encoding scheme, a second encoding scheme, or a third encoding scheme, wherein the first encoding scheme is configured to encode a signal, wherein the second encoding scheme is a spatial encoding scheme, wherein the third encoding scheme is different from the first encoding scheme and the second encoding scheme, and wherein the third encoding scheme comprises channel copy encoding.

15. The electronic device of claim 14, wherein the first encoding scheme combination comprises first encoding schemes corresponding to at least two channels and second encoding schemes corresponding to K channels, and wherein the first encoding scheme and the second encoding schemes are different, wherein K is a first positive integer.

16. The electronic device of claim 15, wherein the scene audio signal comprises an audio signal with C channels, wherein the first encoding scheme combination comprises third encoding schemes corresponding to the C channels, wherein the one or more processors are further configured to execute the program instructions to further cause the electronic device to encode the scene audio signal by encoding the C channels based on the third encoding schemes, wherein Cis a second positive integer, and wherein K is greater than or equal to C.

17. The electronic device of claim 13, wherein the one or more processors are further configured to execute the program instructions to further cause the electronic device to search the encoding scheme set for the first encoding scheme combination based on current scene information.

18. A computer-readable storage medium comprising a computer program that when executed by one or more processors, causes an electronic device to:
obtain a scene audio signal; and
encode the scene audio signal based on a first encoding scheme combination that corresponds to the scene audio signal and that is from an encoding scheme set, wherein the encoding scheme set comprises encoding scheme combinations corresponding to different types of scene information.

19. The computer-readable storage medium of claim 18, wherein the first encoding scheme combination comprises a first encoding scheme, a second encoding scheme, or a third encoding scheme, wherein the first encoding scheme is configured to encode a signal, wherein the second encoding scheme is a spatial encoding scheme, wherein the third encoding scheme is different from the first encoding scheme and the second encoding scheme, and wherein the third encoding scheme comprises channel copy encoding.

20. The computer-readable storage medium of claim 18, wherein the scene audio signal comprises an audio signal with C channels, wherein the first encoding scheme combination comprises second encoding schemes corresponding to the C channels, and wherein the computer program further causes the electronic to encode the scene audio signal by encoding the C channels based on the second encoding schemes, wherein C is a second positive integer.
